(19) United States
(12) Patent Application Publication
(10) Pub. No.: US 2011/0231465 A1
(43) Pub. Date: Sep. 22, 2011

(54) Residue Number Systems Methods and Apparatuses

(76) Inventor: Dhananjay S. Phatak, Ellicott City, MD (US)

(21) Appl. No.: 13/044,343

(22) Filed: Mar. 9, 2011

Related U.S. Application Data
(60) Provisional application No. 61/311,815, filed on Mar. 9, 2010.

(51) Int. Cl. G06F 7/72

(52) U.S. Cl. 708/235; 708/491

(57) ABSTRACT

A method for performing reconstruction using a residue number system includes selecting a set of moduli. A reconstruction coefficient is estimated based on the selected set of moduli. A reconstruction operation is performed using the reconstruction coefficient.

### CROSS REFERENCE TO RELATED APPLICATIONS

This patent claims the benefit of priority from U.S. Provisional Patent Application Ser. No. 61/311815, entitled “Ultrafast Residue Number System Using Intermediate Fractional Approximations That Are Rounded Directionally, Scaled and Computed,” filed on Mar. 9, 2010, incorporated herein by reference in its entirety.

### FIELD OF THE INVENTION

The invention relates to performing residue number system calculations, and in particular, to reduced complexity algorithms and hardware designs for performing residue number system calculations. This invention is in the field of the Residue Number Systems (RNS) and their applications.

### §1 BACKGROUND OF THE INVENTION

The RNS uses a set “ [symbol] ” of pair-wise co-prime positive integers called as the “moduli” [symbol] ={m₁, m₂, . . . , mᵣ, . . . , mₖ} where mᵣ>1 ∀r ∈ [1, K] and gcd (mᵢ, mⱼ)=1 for i≠j (B-1)

Note that | [symbol] |=the number of moduli=K (also referred to as the number of “channels” in the literature)

We use the term “component-modulus” to refer to any single individual modulus (ex: mᵣ) in the set [symbol] .

For the sake of convenience, we also impose an additional ordering constraint: mᵢ<mⱼ if i<j

Total-modulus [symbol] [symbol] m₁×m₂× . . . ×m_{K}. Typically [symbol] >>K (B-2)

Any integer Z ∈ [0, [symbol] , can be uniquely represented by the ordered-touple (or vector) of residues:

∀ Z ∈ [0, [symbol] −1]; Z≡ [symbol] =[z₁, z₂, . . . , z_{K}] where, zᵣ=(Z mod mᵣ), r=1, . . . , K (B-3)

Conversion from residues back to an integer is done using the “Chinese Remainder Theorem” as follows:

Z=(Z_{T} mod [symbol] ) (B-4) where

$${Z}_{T} = ( {\sum }_{r = 1}^{K} {ℳ}_{r} \cdot {ρ}_{r} )$$

### (B-5)

pᵣ=((zᵣ·wᵣ) mod mᵣ), r=1, . . . , K where (B-6)

outer-weights

$${ℳ}_{i} = \frac{{m}_{i}}{} ;$$

inner-weights

$${w}_{i} = ( \frac{1}{{ℳ}_{i}} mod {m}_{i } )$$

are constants for a given [symbol] (B-7)

The Residue Number Systems (abbreviated “RNS”) have been around for while [4]. The underlying Residue Domain representation (or simply Residue Representation, abbreviated “RR”) has some unique attributes (explained below) that make it attractive for signal processing. It is therefore not surprising that the early work in this area was contributed by the signal-processing community.

Thereafter, from the late 1970s through the mid 1980s, the field of cryptology was revolutionized by the invention of the 3 most fundamental and widely used cryptology algorithms, viz., Diffie-Hellman, RSA, and Elliptic-curves. In the beginning, the aforementioned cryptology algorithms were not easy to implement in hardware. However, as semiconductor device sizes kept on shrinking, the hardware that could be integrated on a single chip kept on becoming larger as well as faster. As a result, today (in 2011) it possible to easily realize the cryptographic (abbreviated “crypto”) algorithms in hardware. The word-lengths used in crypto methods are substantially larger as compared with wordlengths required by other applications; typical crypto word lengths today are at least 256 bits or higher. It turns out that the same attributes of the Residue Number Systems that are attractive for signal processing are also beneficial when implementing cryptographic algorithms at long word-lengths. Consequently the cryptology and computer-arithmetic communities also started researching RNS. This coincidental convergence of goals (to research and improve RNS, which is now shared by the signal processing, cryptology as well as computational/computer arithmetic communities) has in-turn led to a resurgence of interest as well as activity in the RNS [5].

§1.1 Advantages of the Residue Domain Representation

The main advantage of the Residue Number (RN) system is that in the Residue-Domain (RD), the operations {±, ×, [symbol] } can be implemented on a per-component/channel basis, wherein the processing required in any single channel is completely independent of the processing required in any other channel. In other words, these operations can be implemented fully in parallel on a per-channel basis as follows:

Z̅= X̅ [symbol] Y̅ [symbol] [zᵣ=(xᵣ [symbol] yᵣ) mod mᵣ)], r=1, . . . , K where [symbol] ∈ {±, ×, ?} (1)

Note that equality of two numbers can be checked by comparing their residues which can be done in parallel in all channels. In other words, in the RD, the most fundamental operations viz., addition/subtraction, equality check AND Multiplication can all be performed in parallel in each channel independently of any other channel(s). This independence of channels implies that each of the above operations can be implemented with O(n) computing effort (operations/steps), where

┌lg [symbol] ┐=n (2)

i.e., n is the number of bits required to represent the total-modulus [symbol] or the overall range of the RNS.

In contrast, in the regular integer domain, a multiplication is a convolution of the digit-strings representing the two numbers being multiplied. A convolution is substantially more expensive than add/subtract operations (Addition/Subtraction fundamentally require O(n) operations and can be implemented in O(lg n) delay using the “carry-look-ahead” method and its variants. Naive paper-and-pencil multiplication, requires O(n²) operations. Asymptotically fastest multiply methods use transforms such as floating point FFT (Fast Fourier Transform) or number-theoretic transforms to convert the convolution in the original domain into a point-wise product in the transform domain, so that the number of operations required turns out to be ≈O(nlg n); for further details, please refer to [2]).

Thus, performing the multiplications in the RD is substantially faster as well as cheaper (in terms of interconnect length and therefore h/w area as well as power consumption). Consequently, wherever multiplication is heavily used, adopting the RR can lead to smaller and faster realizations that also consume less power. For example:

(i) Filtering is heavily used in signal processing. Most of the effort in filtering is in the repeated multiply and add operations. It is therefore not surprising that the first practical use of the RNS was in synthesizing fast filters for signal processing.

(2) Multiplication (note that squaring is a special case of multiplication) also gets used heavily in long-wordlength cryptology algorithms. Therefore RD implementations of cryptological algorithms are also smaller, faster and consume lower power.

§1.2 Disadvantages of the Residue Domain Representation

Together with the advantages, also come some of the disadvantages of the residue domain: when compared to the “easy operations” above, several fundamental operations are relatively a lot more difficult to realize in the RD [4, 6-8]:
1. Reconstruction or conversion back to a weighted, non redundant positional representation (ex, binary or decimal or the “mixed-radix” representation [6])
2. Base extension or change.
3. Sign and overflow detection or equivalently, a magnitude-comparison.
4. Scaling or division by a constant, wherein, the divisor is known ahead of time (such as the Modulus in the RSA or Diffie-Hellman algorithms)
5. Division by an arbitrary divisor whose value is dynamic, i.e., available only at run-time.

Reconstruction in the regular format by directly using the CRT turns out to be a slow operation. Note that a straightforward/brute-force application of the CRT entails directly implementing Equation (B-4). Accordingly, Z_{T} is fully evaluated first, and then a division by the modulus M is carried out to retrieve the remainder (Z). For long word-lengths (ex, in cryptography applications) the final division by M is unacceptably slow and inefficient.

Re-construction by evaluating the mixed-radix representation takes advantage of the “mixed-radix” representation associated with every residue-domain-representation [6], wherein a number is represented by an ordered set of digits. The value of the number is a weighted sum where the weights are positional (just like the weights of a normal single radix decimal or binary representation). As a result, a digit-by-digit comparison starting with the most-significant-digit is feasible. However, to the best of our knowledge it takes O(K²) sequential operations (albeit on small sized operands of about the same size as the component-moduli mᵢ) in the residue-domain. The inherently sequential nature of this method makes it slow.

Moreover, at a first glance, it appears that for magnitude-comparison and division, the operands need to be fully reconstructed in the form of a unique digit string representing an integer either in the regular or the mixed-radix-format.

§1.3 Related Prior Art

§1.3.1 Base-Extension or Change

In a sign-magnitude representation or a radix-complement (such as the two's complement) representation, a 32 bit integer can be easily extended into a 64 bit value. The corresponding operation in the RNS is considerably more involved. Related Prior work in this area falls under two categories, each is briefly explained next.

§1.3.1.A Deploying a Redundant Modulus

Shenoy and Kumarersan [9] start by re-expressing the CRT in a slightly different form:

Z=Z_{T}−α· [symbol] where 0 [symbol] α [symbol] K−1

In the above equation α= [symbol] _{C} is the only unknown. It is clear that knowledge of (Z mod mₑ), i.e., the residue/remainder of Z, w.r.t. one extra/redundant modulus mₑ is sufficient to determine the value of [symbol] _{C}. They assume the availability of such an extra residue, which lets them evaluate α= [symbol] _{C}.

This base extension method has been widely adopted in the literature. For example, Algorithms for modular multiplication developed by Bajard et. al. [10, 11] perform their computations in two independent RNS systems and change base from one to the other using the shenoy-kumaresan method. This is done so as to avoid a full reconstruction at intermediate steps. As a result, they end up requiring a base-conversion in each step and consequently, their algorithm requires O(K) units of delay when O(K) dedicated processing elements are available (where K=the total number of moduli or channels in the RNS system).

§1.3.1.B Iterative Determination of [symbol] _{C}

Another base-extension algorithm related to our work is described in [12-15]. They show a method to evaluate an approximate estimate [symbol] in a recursive, bit-by-bit (i.e., one bit-at-a-time) manner and then derive conditions under which the approximation is error-free. This method is at the heart of their base-extension algorithm.

The recursive structure of this method makes it relatively slower and cumbersome.

The idea of using the “fractional-representation” of CRT has been around for a while. For instance, Vu [16, 17] proposed using a Fractional interpretation of the CRT in the mid 1980s. However, he ends up using a very high (actually the FULL) precision: [lg (K· [symbol] )] bits (see equations (13) and (14) in reference [17]).

§1.3.2 Sign Detection and Magnitude Comparison

In the RNS, the total range is divided into positive and negative intervals of the same length (to the extent possible). For example, if the set of RNS moduli is [symbol] ={2, 3, 5, 7} then [symbol] =210 and the overall range of the RNS is [−105,+104], where,

the numbers 1 through 104 represent +ve numbers, and

the numbers 105 thru 209 represent −ve numbers from −105 to −1, respectively.

In general, all negative values in the range [−( [symbol] −1), −1] satisfy the relation

(−α) mod [symbol] ≡ [symbol] −α (3)

Sign detection in the RNS is not straightforward, rather, it has been known to be relatively difficult to realize in the Residue Domain.

Likewise, comparison of magnitudes of two numbers represented as residue touples is also not straightforward (independent of whether or not negative numbers are included in the representation). For instance, with the same simple moduli set [symbol] ={2,3,5,7} above, note that 18≡(1, 1, 4, 5) and 99≡(1,0,4,1) while 79≡(1, 1, 4, 1) and the negative number −101≡(1,1,4,4).

In other words, the touples of remainders corresponding to +ve and −ve numbers cannot be easily distinguished.

Prior Work on Sign Detection and Magnitude Comparison

Sign detection operation has been known to be relatively difficult to realize in the RNS for a while (early works date back to 1960's, for example [4,18]). Recent works related to Sign detection in RNS have tended to focus on using moduli having special forms [19, 20], which limits their applicability. The idea of “core-functions” was introduced in [21] in the context of coding-theory. RNS sign-detection algorithms based on idea of using “core-functions” have been published [22-24]. However, these methods are unnecessarily complicated and appear to be useful only with moduli with special properties [24], limiting their applicability.

Lu and Chiang [25, 26] introduced a method to use the least significant bit (lsb) to keep track of the sign. However, tracking the lsb of arbitrary (potentially all possible) numbers is not an easy task. In their quest to keep track of the lsb, Lu and Chiang first proposed an exhaustive method in their first publication [25]; which turns out to be infeasible for all but small toy examples because the size of their look-up table was the same as the total range M. In the follow up publication, they abandoned the exhaustive look-up approach [26] and ended up unnecessarily using the full precision, just as Vu does in his work [17].

§1.3.3 Scaling or Division by a Constant

In general, “scaling” includes both multiplication as well as division by a fixed constant, (viz., the scaling factor S_{f}). Early versions of signal processors often deployed a fixed-point format which necessitated scaling to cover a wider dynamic range of input values. Consequently, scaling has been heavily used in signal processing. It is therefore not surprising that the early work in realizing the scaling operation in the residue-domain comes from the signal-processing community [27, 28].

Shenoy and Kumaresan [29, 30] introduced a scaling method that works only if the constant divisor has the special form

D=m_{d}_{₁}·m_{d}_{₂} . . . m_{d}_{ₛ} wherein s<K and

{m_{d}_{₁}, m_{d}_{ₛ} . . . m_{d}_{ₛ}}⊂{m₁, m₂, . . . , mₖ}= [symbol] =the set of RNS moduli (4)

i.e., the divisor is a factor of the overall modulus M. This restriction renders their method inapplicable in most cryptographic algorithms; because the modulus (aka, the constant divisor) N is either a large prime number (as in elliptic curve methods) or a product of two large primes numbers (as in RSA). In either case, it does not share a factor with the total modulus [symbol] .

All methods and apparata for scaling in the RNS that have been published thus far [23, 31-33]; including more recent ones [33-35] are either limited to special moduli or are more involved than necessary because they all attempt to estimate the remainder first, subtract it off and then arrive at the quotient, which is the quantity of interest in scaling. Consequently, none of the methods or apparata are even remotely similar to the new algorithm that I have invented for RNS division by a constant.

### §2 SUMMARY OF THE INVENTION

The following presents a simplified summary in order to provide a basic understanding of some aspects of the claimed subject matter. This summary is not an extensive overview, and is not intended to identify key or critical elements, or to delineate any scope of the disclosure or claimed subject matter. The sole purpose of the subject summary is to present some concepts in a simplified form as a prelude to the more detailed description that is presented later. In one exemplary aspect, a method for performing reconstruction using a residue number system is disclosed. A set of moduli is selected. A reconstruction coefficient is estimated based on the selected set of moduli. A reconstruction operation is performed using the reconstruction coefficient. In another exemplary aspect, an apparatus for performing reconstruction using a residue number system includes means for selecting a set of moduli, means for estimating a reconstruction coefficient based on the selected set of moduli and means for performing a reconstruction operation using the reconstruction coefficient. In yet another exemplary aspect, a computer program product comprising a non-volatile, computer-readable medium, storing computer-executable instructions for performing reconstruction using a residue number system, the instructions comprising code for selecting a set of moduli, estimating a reconstruction coefficient based on the selected set of moduli and performing a reconstruction operation using the reconstruction coefficient is disclosed. In yet another exemplary aspect, a method for performing division using a residue number system comprises selecting a set of moduli, determining a reconstruction coefficient and determining a quotient using an exhaustive pre-computation and a look-up strategy that covers all possible inputs. In yet another exemplary aspect, a method of computing a modular exponentiation in a residue number system includes iterating, without converting to a regular integer representation, by performing modular multiplications and modular squaring and computing the modular exponentiation as a result of the iterations.

### §3 BRIEF DESCRIPTION OF DRAWINGS

FIG. 1: shows summation of fraction estimates (obtained via look-up-tables) to estimate the Reconstruction Coefficient.

FIG. 2: is a flow chart for the Reduced Precision Partial Reconstruction (“RPPR”) algorithm.

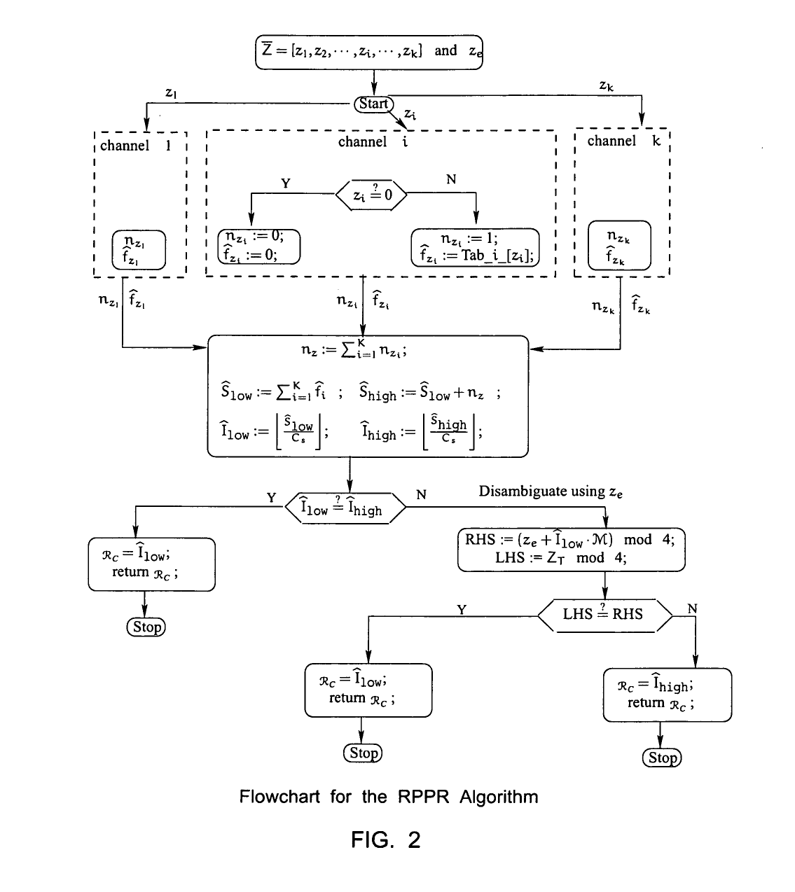

FIG. 3: is a schematic block diagram of a generic architecture to implement the RPPR algorithm.

FIG. 4: illustrates conventional method of incorporating negative integers in the RNS.

FIG. 5: illustrates sign and Overflow Detection by Interval Separation (SODIS).

FIG. 6: Flow chart for the Quotient First Scaling (QFS) algorithm.

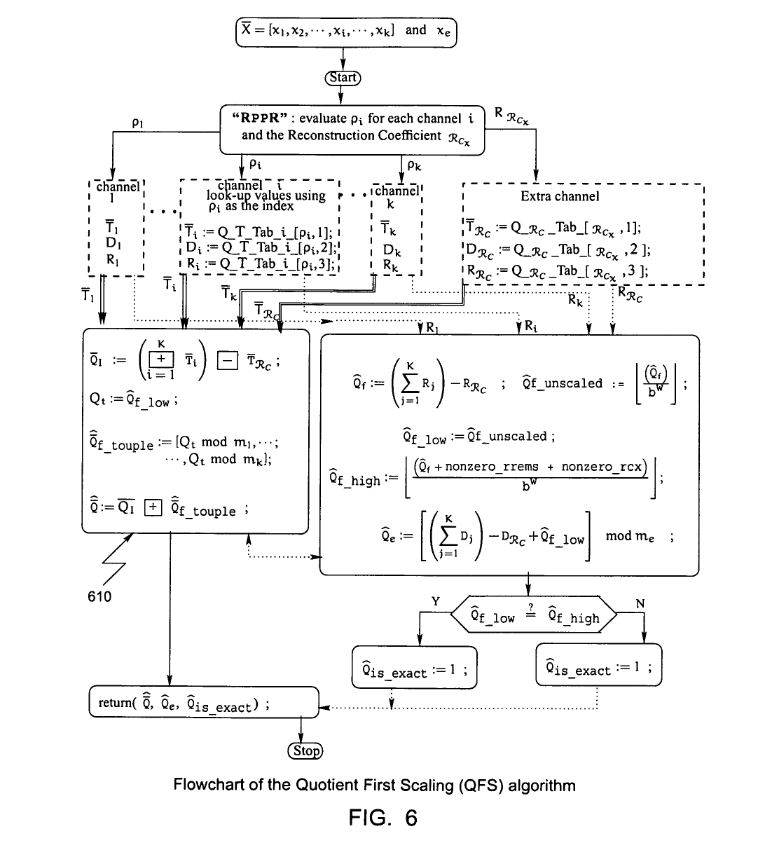

FIG. 7: is a schematic timing diagram for the QFS algorithm.

FIG. 8: is a flow chart for the modular exponentiation algorithm

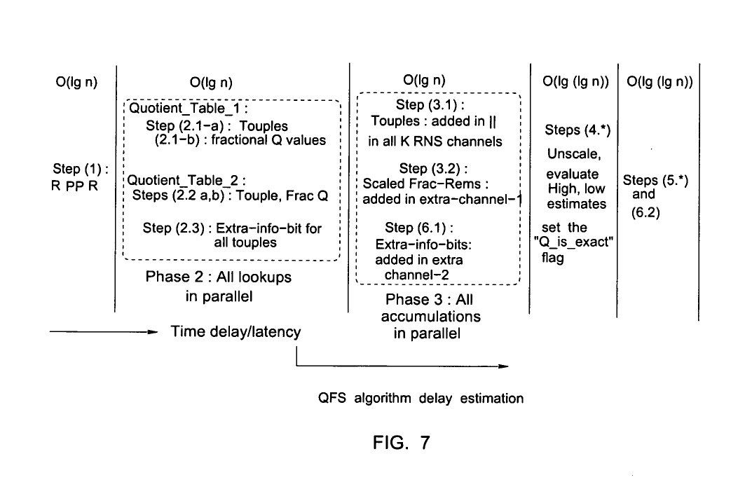

FIG. 9: is a flow chart representation of a process of performing reconstruction using a residue number system.

FIG. 10: is a block diagram representation of a portion of an apparatus for performing reconstruction using a residue number system.

FIG. 11: is a flow chart representation of a process of performing division using a residue number system.

FIG. 12: is a block diagram representation of a portion of an apparatus for performing division using a residue number system.

FIG. 13: is a flow chart representation of a process of computing a modular exponentiation using a residue number system.

FIG. 14: is a block diagram representation of a portion of an apparatus for computing a modular exponentiation using a residue number system.

### §4 DETAILED DESCRIPTIONS

In this section, first, I explain my moduli-selection method. After that, each new algorithm illustrated in detail. Since the “RPPR” algorithm is used in all others, it has been explained in more detail than other algorithms.

### Notations Used in this Document

Notations-1 Math Functions, Symbols

The symbol ≡ means “equivalent-to”; whereas the symbol [symbol] means “is defined as”

LHS [symbol] Left Hand Side of a relation; RHS [symbol] the right-hand-side

a mod b [symbol] the remainder when integer a is divided by integer b.

ulp≡wight or value a unit or a “1” in the least-significant-place

gcd [symbol] greatest common divisor (also known as highest common factor or hcf)

lg≡log-to-base 2, ln≡log-to-base-c, log≡log-to-base-10

floor function: └x┘=the largest integer [symbol] x≡Round to the nearest integer toward−∞

ceiling function: ┌x┐=the smallest integer [symbol] x≡Round to the nearest integer toward+∞

truncation: trunc(x)=only the integer-part of x≡Round toward 0

O( )≡Order-of or the big-O function as defined in the algorithms literature (for example see [2]). |•|≡cardinality if argument is a set; ≡absolute value of integer argument.

“RR” is abbreviation for “Residue Representation”, “RD” is abbreviation for “Residue Domain”, “integer-domain” refers to the set of all integers [symbol] .

[symbol] denotes the “equality-check” operation.

Notations-2 Algorithm Pseudo-Code

The pseudo-code syntax closely resembles MAPLE [3] syntax.

Lines beginning with # as well as everything between /* and */ are comments.

All entities/variables with a bar on top are vectors/ordered-touples (ex, Z̅≡[z₁, . . . , z_{K}])

Operations that can be implemented in parallel in all channels are shown inside a square/rectangular box. for example Z̅= X̅ [symbol] Y̅ [symbol] [zᵣ=(xᵣ ‡ yᵣ) mod)], r=1, . . . , K

### Brief Introduction to RNS and Canonical Definitions

Definition 1: We define “Reconstruction-Remainders” to be the component-wise values p₁, p₂, . . . , p_{K} defined by relations (B-6) above.

Note that Equation (B-4) can be re-written as Z_{T}=Z+Q·M (B-8.1) or equivalently as Z=Z_{T}−Q·M where, (B-8.2)

$$Q = ⌊ \frac{{Z}_{T}}{} ⌋ = Quotient$$

when Z_{T} is divided by [symbol] [symbol] [symbol] _{C} [symbol] 0 [symbol] [symbol] _{C} [symbol] K−1 (B-9)

Definition 2: We define the coefficient of [symbol] (which is denoted by the variable Q) in Equations (B-8*) to be the “Reconstruction-Coefficient” and henceforth denote it by the dedicated symbol “ [symbol] _{C}”

Definition 3: Full reconstruction of the integer corresponding to a residue-touple refers to the process of retrieving the entire unique digit-string representing that integer in a non-redundant, weighted-positional format (such as two's complement or decimal or the mixed-radix format).

D-4: Full-precision≡d_{T} base-b digits; where d_{T}=┌log_{b}( [symbol] K)┐≈┌log_{b} [symbol] ┐ [symbol] n_{b}; since [symbol] >>K (B-10)

If the base b=2 then n_{b}=n₂ is the bit-length required to represent the total modulus [symbol] or the overall range of RNS; and is therefore also denoted simply by the variable n without any subscript.

Definition 5: Any method/algorithm that simply determines the value of [symbol] _{C} without attempting to fully reconstruct Z is referred-to as a “Partial-Reconstruction” (PR).

Evaluating [symbol] _{C} yields an exact equality (Eqn. (B-8.2)) for the target integer Z, without any “mod” i.e., remaindering operations in it (unlike the statement of CRT, Eqn. (B-4)). For most operations (especially division with a constant) such an exact equality for Z suffices, i.e., there is no need to fully reconstruct Z. This is why Partial-Reconstruction (i.e., evaluating [symbol] _{C}) is an important enabling step underlying most other operations

§4.1 Moduli Selection

Note that a modulus of value mᵣ needs a table with (mᵣ−1) entries to cover all possible values of the reconstruction-remainder pᵣ w.r.t. mᵣ, (excluding the value 0). Therefore, the total number of memory locations required by all moduli is

$$\# memory locations required = {\sum }_{r = 1}^{K} ( {m}_{r} - 1 ) \approx {\sum }_{r = 1}^{K} {m}_{r} {𝕋}_{𝕄} \qquad ( 5 )$$

Thus, in order to minimize the memory needed, each component modulus should be as small as it can be.

Therefore, in order to cover a range [0, R] we select smallest consecutive K prime numbers starting with either 2 or 3, such that their product exceeds R: [symbol] ={m1, m2, . . . , m_{K}}={2, 3, . . . , K-th prime number}, where

$${\prod }_{t = 1}^{K} {m}_{t} = > R \qquad ( 6 )$$

This selection leads to the following two analytically tractable approximations:

[symbol] [symbol] The notation defines m_{K} to be the K-th prime number. In other words, K is the index of prime number whose value is m_{K}. Consequently, K and m_{K} can be related to each other via the well-known “prime-counting” function [36] defined as

$$\begin{matrix}π ( x ) = ( The number of prime numbers \leq x ) \approx \frac{x}{ln x} and therefore & ( 7 ) \\ K = π ( {m}_{k} ) \approx ( \frac{{m}_{k}}{ln {m}_{k}} ) & ( 8 )\end{matrix}$$

[symbol] 2 [symbol] The overall modulus [symbol] becomes the well known “primorial” function [37] which for any positive integer N is denoted as “N#” and defined as

$$\begin{matrix}N \# = 1 if N = 1 \\ = ( product of all prime numbers \leq N ) , otherwise\end{matrix} \qquad ( 9 )$$

(Note that a the definition as well as the notation for the primorial is analogous to the well known “factorial” function (N!)). The primorial function satisfies well-known identities [37, 38]

2^{N}<(N#)<4^{N}=2^{2N} and (10)

(N#)≈O(e^{N}) for large N (11)

As a result, to be able to represent n bit numbers (i.e. the range [0,2ⁿ−1]), in the residue domain using all available prime numbers (starting with 2), the total modulus satisfies

[symbol]

≈exp (m_{K})>2ⁿ and therefore (12)

m_{K}≈(ln [symbol] )=ln(2ⁿ)=n·ln2 (13)

Substituting this value of m_{K} in Eqn. (8), K, the number of moduli required to cover all “n”-bit long numbers can be approximated as :

$$K = π ( {m}_{k} ) \approx ( \frac{{m}_{k}}{ln {m}_{k}} ) \approx \frac{n ln 2}{ln ( n ln 2 )} \approx O ( \frac{n}{ln n} ) \approx O ( \frac{lg }{( ln [ lg ℳ ] )} ) \qquad ( 14 )$$

These analytic expressions are extremely important because they imply:

A.1 K<m_{K}<< [symbol] (which follows from relations (13) and (14) above.) Moreover, both (15)

A.2 maximum-modulus m_{K} as well as the number of moduli K grow logarithmically w.r.t. [symbol] (16)

i.e., linearly w.r.t. the wordlength n (since n=┌lg [symbol] ┐).

§4.1.1 moduli selection enables exhaustive look-up strategy that covers all possible inputs

The attributes A.1 and A.2 make it possible to exhaustively deploy pre-computation and lookup because they guarantee that the total amount of memory required grows as a low degree polynomial of the wordlength n.

In other words, the main novelty in my method of moduli selection and its real significance is the fact that I leverage the selection to enable an exhaustive pre-computation and look-up strategy that covers all possible input cases. This exhaustive pre-computation and look-up in turn makes my algorithms extremely simple, efficient and therefore ultrafast because I deploy the maximum amount of pre-computation possible, and perform as much of the task ahead of time as possible; so that there is not much left to be done dynamically at run-time (a perfect example of this is the new “Quotient First Scaling” algorithm for RNS division by a constant divisor that is explained in detail in Section §4.5 below).

In other words, the “minimization” of the total number of look-up table entries is the best possible scenario, but it is not necessary to obtain the major benefits that are illustrated for the first time in this invention. There is a lot more flexibility in selecting the moduli as long as they do not make it infeasible to deploy the exhaustive precomputation strategy.

Consider a concrete example: Suppose the claims section says “select moduli so as to minimize the total amount of look-up table memory required.”

If the desired range is all 32-bit numbers, then the set of moduli [symbol] ={2,3,5,7, 11,13, 17,19, 23,29} minimizes the total number of look-up table entries required.

Now, one can replace any component modulus from the above set (for example, say the modulus 29) with another prime number (such as 31, 37 or even 101). The resulting moduli set does not minimize the total number of look-up table entries required, but it is sufficiently close and would not make much of a difference in the ability to deploy the exhaustive precomputation strategy. In the strict sense, however, the modified moduli set does not satisfy the “minimization” criteria and this fact might be used to wiggle around having to acknowledge the use of intellectual property claimed by this patent.

We would therefore like to clarify that the spirit of this part of the invention (i.e., the moduli selection method) can be better captured by the following description:

Select the set moduli so as to simultaneously bound both

(i) mₖ=the maximum value in the set of moduli [symbol] by a low degree polynomial in n, as well as

(ii) K=the total number of moduli in the set [symbol] = [symbol] (also known as the number of RNS channels) by another low degree polynomial in the wordlength n.

(both polynomials could be identical which is a special case). Following usual practices, we consider any polynomial of degree [symbol] 16 to be a low-degree polynomial.

In closing we would like to point out some additional benefits of our moduli selection:
+1: This selection is general, in the sense that for any value of R multiple moduli sets always exist.
+2: The moduli are relatively easy to find, since prime numbers are sufficiently densely abundant irrespective of the value of R.
+3: It fully leverages the parallelism inherent in the RNS
+4: limiting m_{K} and K to small values makes it more likely that the entire RNS fits in a single h/w module.

§4.2 The Reduced Precision Partial Reconstruction (“RPPR”) Algorithm

This is a fundamental algorithm that underlies all other algorithms to follow. To speed-up the Partial-Reconstruction, we combine the information contained in both integer as well as fractional domains. We express the CRT in the form:

$$\begin{matrix}\frac{{Z}_{T}}{} = {R}_{C} + \frac{Z}{ℳ} = ( {\sum }_{r = 1}^{K} \frac{{ρ}_{r}}{{m}_{r}} ) {=}^{Δ} S where , {f}_{r} = \frac{{ρ}_{r}}{{m}_{r}} ⇒ & ( 17 ) \\ {C}_{} = ⌊ S ⌋ = the integer part of the sum of fractions , and & ( 18 ) \\ \frac{Z}{ℳ} = ( S - ⌊ S ⌋ ) = the fractional part of the sum of fractions & ( 19 )\end{matrix}$$

Relation (18) states that [symbol] _{C} can be approximately estimated as the integer part of a sum of at most K proper fractions fᵣ, r=1, . . . , K. (proper fractions because the numerator pᵣ is a remainder w.r.t. mᵣ; and therefore it is strictly less than mᵣ).

To speed up such an estimation of the [symbol] _{C}, we leverage pre-computation and look-up: for each modulus mᵣ, we pre-calculate the value of each of the (mᵣ−1) fractions, i.e., all possible fractions that can occur, and store them in the look-up table (denoted by [symbol] mᵣ)

$${𝕋}_{{m}_{r}} = [ \frac{1}{{m}_{r}} , \frac{2}{{m}_{r}} , … , \frac{{ℳ}_{r} - 2}{{m}_{r}} , \frac{{m}_{r} - 1}{{m}_{r}} ] \\ ⇒ the i \text{-} th entry in the table = {𝕋}_{{m}_{r}} [ i ] = {f}_{i , r} = \frac{i}{{m}_{r}} \qquad ( 20 )$$

(if pᵣ=0 then the table entry is 0 which need not be explicitly stored).

The important point is that The look-up table for each modulus mᵣ can be accessed independent of (and therefore in parallel with) the look-up table for any other modulus mₛ where r≠s.

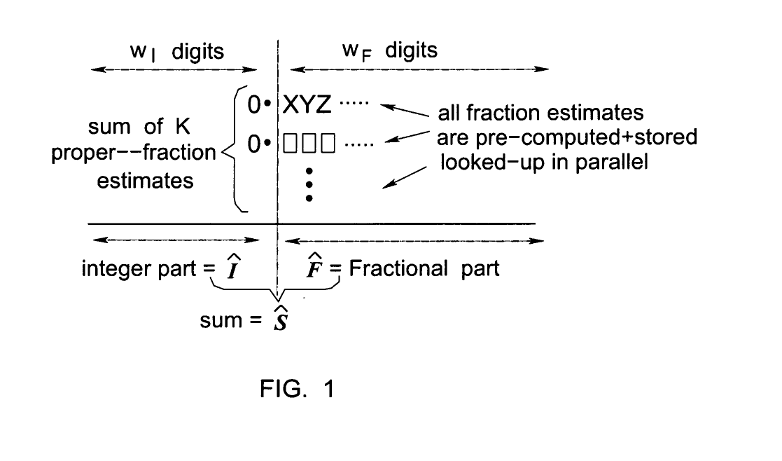

The fractional values (obtained from the tables) are then added up as illustrated in FIG. 1

§4.2.1 Derivation of the Algorithm and Novel Aspects Therein

\textcircled{1} First, note that we need to estimate the integer part of a sum of fractions, i.e., we need to be able to accurately evaluate the most-significant digits/portion of the sum as illustrated in FIG. 1. The important point is that whenever a computation needs to generate the “most-significant” bits/digits of the target, approximation methods can be used. For instance, in a division, “Quotient” is a lot easier to approximate than the “Remainder”.

In other words, using the rational-domain interpretation allows us to focus on values that represent the “most-significant” bits/digits of the target and therefore approximation methods can be invoked.

\textcircled{2} The implication is that the precision of the individual fractional values that get added need not be very high. All that is required is that the fractions

$${f}_{i , r} = \frac{i}{{m}_{r}}$$

be calculated to enough precision so that when they are all added together, the error is small enough so as not to reach up-to and affect the least significant digit of the integer part (to the extent possible).

Let the radix/base of the number representation be b and let w_{f} be the number of fractional (radix-b) digits required. Then, for each fraction fᵢ we generate an upper and lower bound as follows:

$$For {ρ}_{i} \neq 0 , let \frac{{ρ}_{i}}{{m}_{i}} = {f}_{i} the exact value of the reconstruction \text{-} fraction in channel i \qquad ( 21 )$$

fᵢ=0.d₁d₂ . . . d_{w}_{_{f}}|d_{w}_{_{f}}₊₁d_{w}_{_{f}}₊₂ (22)

Truncation of fᵢ to w_{f} digits yields an under-estimate: \hat{f}ᵢ_{_{—}}_{low}=0.d₁d₂ . . . d_{w}_{_{f}} [symbol] fᵢ (23)

and 0 [symbol] (fᵢ−\hat{f}ᵢ_{_{—}}_{low})=0.0 . . . 0d_{w}_{_{f}}₊₁d_{w}_{_{f}}₊₂ . . . <1/b^{w}^{_{f}} (24)

However, a ceiling or rounding-toward-∞ to retain w_{f} fractional digits adds a ulp to the least significant digit (lsd), yielding an over-estimate: (25)

$$\begin{matrix}\begin{matrix} {\hat{f}}_{i\_high} = 0 \cdot {d}_{1} {d}_{2} … [ ( {d}_{{w}_{f}} ) + 1 ] \\ = {\hat{f}}_{i\_low} + ulp \geq {f}_{i} where ulp = \frac{1}{{b}^{{w}_{f}}}\end{matrix} & ( 26 ) \\ and 0 \leq ( {\hat{f}}_{i\_high} - {f}_{i} ) < 1 / {b}^{{w}_{f}} & ( 27 ) \\ combining ( 23 ) and ( 26 ) we get {\hat{f}}_{i\_low} \leq {f}_{i} \leq {\hat{f}}_{i\_high} = ( {\hat{f}}_{i\_low} + ulp ) & ( 28 ) \\ ( {\hat{f}}_{l\_low} + … + {\hat{f}}_{K\_low} ) \leq ( {f}_{1} + … + {f}_{K} ) = {C}_{} + \frac{Z}{} \leq ( {\hat{f}}_{l\_low} + … + {\hat{f}}_{K\_low} ) + {n}_{z} \cdot ulp & ( 29 ) \\ where , {n}_{z} = number\_of \_nonzero \_residues \_in \_the \_touple & ( 30 )\end{matrix}$$

The understand the upper limit in relation (29) above, note that each non-zero pᵢ makes the corresponding over-estimate higher than the under-estimate by a ulp, as per Eqns (21), (23) and (26).

Let \hat{S}_{low} [symbol] (\hat{f}ₗ_{_{—}}_{low}+ . . . +\hat{f}_{K}_{_{—}}_{low}) and \hat{I}_{low} [symbol] └\hat{S}_{low}┘=integer part of \hat{S}_{low} (31)

\hat{S}_{high} [symbol] \hat{S}_{low}+n_{z}·ulp and \hat{I}_{high} [symbol] └\hat{S}_{high}┘=integer part of \hat{S}_{high} (32)

Taking the “floor” of each expression in the inequalities in relations (29) above; substituting the floors from Eqns (31) and (32); and using the identity

$$\begin{matrix} ⌊ {C}_{} + \frac{Z}{} ⌋ = {ℛ}_{C} we obtain & ( 33 ) \\ {\hat{I}}_{low} \leq {ℛ}_{C} \leq {\hat{I}}_{high} so that & ( 34 ) \\ if {\hat{I}}_{low} = {\hat{I}}_{high} then the estimate {ℛ}_{C} = {I}_{high} = {I}_{low} must be exact & ( 35 )\end{matrix}$$

since both upper and lower bounds converge to the same value. In practice (numerical simulations), this case is encountered in an overwhelmingly large fraction of numerical examples. Moreover,

$$\begin{matrix} Since {n}_{z} \leq K ⇒ {n}_{z} \cdot ulp \leq K \cdot ulp & ( 36 ) \\ by selecting {w}_{f} so as to ensure K \cdot ulp = K / {b}^{{w}_{f}} < 1 from ( 29 ) we get & ( 37 ) \\ {\hat{S}}_{low} \leq {C}_{} + \frac{Z}{M} \leq {\hat{S}}_{low} + 1 \\ taking the floor of each expression in the relation above yields & ( 38 ) \\ {\hat{I}}_{low} \leq {ℛ}_{C} \leq {\hat{I}}_{low} + 1 & ( 39 )\end{matrix}$$

In other words, even in the uncommon/worst cases, wherein, Î_{low}≠Î_{high}, relation (39) demonstrates that the estimate of [symbol] _{C} can be quickly narrowed down to a pair of consecutive integers.

\textcircled{3} It is intuitively clear that further “disambiguation” between these choices needs at least one bit of extra information. This information is obtained from the value (Z mod mₑ) where mₑ is the extra modulus. For efficiency, mₑ should be as small as possible. Accordingly, our method leads to only two scenarios:

[a] if [symbol] is odd then mₑ=2 is sufficient for disambiguation

[b] otherwise if 2 is included in the set of moduli [symbol] , then mₑ=4 is sufficient for disambiguation

[symbol]

mₑ ∈ {2,4} (this is analytically proved in [39]) (40)

Note that when [symbol] includes “2” as a modulus, it already contains the value (z₁=Z mod 2), i.e., the least significant bit of the binary representation of Z. The value (Z mod 4) therefore conveys only one extra bit of information beyond what the residue touple conveys.

\textcircled{4} It is reasonable to assume that for primary/external inputs the extra-info is available. The exhaustive pre-computations can also assume that the extra-info is available. Starting with these, we generate the extra-bit of information (either explicitly or implicitly) for every intermediate value we calculate/encounter. This is done in a separate dedicated channel. Let

W=*(X) where * is a unary operation. Then, (41)

W mod mₑ=[*(X mod mₑ)] mod mₑ for * ∈ {left-shift, power} (42)

If the operation is a right shift, then finding the remainder of the shifted value w.r.t. mₑ, is slightly more involved but it can be evaluated using a method identical to “Quotient_First_Scaling”, i.e., “Divide_by_Constant', which explained in detail in Section §4.5 below.

Likewise, let

Z=X [symbol] Y where [symbol] is a binary operation. Then, (43)

Z mod mₑ=[(X mod mₑ) [symbol] (Y mod mₑ)] mod mₑ for [symbol] ∈ {±, ×} (44)

Finally, since division is fundamentally a sequence of shift and add/subtract operations, as long as we keep track of the remainder of every intermediate value w.r.t. mₑ, we can also derive the values of (Quotient mod mₑ) and (Remainder mod mₑ). Thus all the basic arithmetic operations are covered.

§4.2.2 Analytical Results

Result 1 Pre-conditions: Let the radix of the original (non-redundant, weighted and positional, i.e., usual) number representation be denoted by the symbol “b” (note that b=10 yields the decimal representation, b=2 gives the binary representation). Suppose integer Z=[z₁, z₂, . . . , z_{K}] is being partially re-constructed and the extra-bit-of-information, i.e., the value of (Z mod mₑ) is also available. Let

$$\begin{matrix}\frac{{Z}_{T}}{} \approx \hat{S} = \hat{I} + \hat{F} = {\sum }_{r = 1}^{K} {\hat{f}}_{r} where , & ( 45 ) \\ \hat{I} = ⌊ \hat{S} ⌋ = the integer part of the approximate sum \hat{S} , and & ( 46 ) \\ \hat{F} = \hat{S} - \hat{I} = the fractional part of the sum , and & ( 47 ) \\ \begin{matrix}{\hat{f}}_{i} = {\hat{f}}_{i\_low} \\ = Trunc [ {w}_{F} ] ( {f}_{i} ) \\ = truncation of {f}_{i} to {w}_{F} digits where\end{matrix} & ( 48 ) \\ {f}_{i} = \frac{{ρ}_{i}}{{m}_{i}} ⇒ 0 \leq {f}_{i} < 1 & ( 49 )\end{matrix}$$

and pᵢ values are the reconstruction-remainders defined in Equation (B-6)

$$\begin{matrix}Let δ = ( \frac{{Z}_{T}}{} - \hat{S} ) be the total error in the approximate estimate \hat{S} & ( 50 ) \\ and let the Reconstruction \text{-} Coefficient {ℛ}_{C} be estimated as {C}_{} \approx \hat{I} then , & ( 51 )\end{matrix}$$

Result 1: In order to narrow the estimate of the Reconstruction Coefficient [symbol] _{C} down to two successive integers, viz., Î or (Î+1), it is sufficient to carry out the summation of the fractions (whose values can obtained from the look-up-tables) in a fixed-point format with no more than a total of w_{T} radix-b digits, wherein

w_{T}=w_{I}=w_{F} where (52)

w_{I}=Number of digits allocated to the Integer part, and (53)

w_{F}=Number of digits allocated to hold the fractional part (54)

where the precisions (i.e., the digit lengths) of the integer and fractional parts satisfy the conditions:

R1.1 w_{I}=┌log_{b} K┐ (55)

R1.2 w_{F}=┌log_{b} (K·Δ_{uuzf})┐ where, K=number of moduli= [symbol] , and (56)

Δ_{uuzf}≡“Unicity Uncertainty Zone Factor”, that satisfies Δ_{uuzf} [symbol] 2 (57)

R1.3 The Rounding mode adopted in the look-up-tables (when limiting the pre-computed values of the fractions to the target-precision) as well as during the summation of fractions as per equation (51) must be TRUNCATION, i.e., discard excess bits.

For the proof of the above result as well as all other analytical results stated below, please refer to [39].

Result 2: In order to disambiguate between the two possible values of the Reconstruction Coefficient i.e., select the correct value (Î) or (Î+1), a small amount of extra information is sufficient.

R2.1 In particular, (prior) knowledge of the remainder of Z (the integer being partially reconstructed), w.r.t. one extra component modulus mₑ that satisfies

gcd( [symbol] , mₑ)<mₑ is sufficient for the disambiguation. (58)

R2.2 For computational efficiency, the minimum value of mₑ that satisfies (58) should be selected.

Such a selection gives rise to the following two canonical cases:
\textcircled{1} [symbol] is odd: In this case, mₑ=2 is sufficient for disambiguation.
\textcircled{2} [symbol] contains the factor 2: then, mₑ=4 is sufficient for disambiguation.

§4.2.3 RPPR Algorithm: Illustrative Examples

The pre-computations and Look-up-tables needed for the partial reconstruction are illustrated next.

§4.2.3.A First an Example with Small Values, to Bootstrap the Concepts

Let the set of moduli be [symbol] ={3,5,7,11}, so that, K=4, [symbol] =1155, and let mₑ=2

TABLE 1
Look-up table for the RPPR algorithm for the RNS-ARDSP system with [symbol]
= {3, 5, 7, 11}. This table uses the value of ρᵣ as the address to look-up
the fraction $( \frac{ρr}{{m}_{r}} )$ [symbol] explicit value of ρᵣ is needed. In this case
K = 4 and Δ_{uuzf} = 2 and therefore w_{I} = ┌log₁₀(4 − 1)┐ = 1 integer
decimal-digit and w_{F} = ┌log₁₀(4 × 2)┐ = 1 fractional decimal-digit.
Accordingly, all the entries in the table have a single fractional digit.
In this toy example we have deliberately left the table entries in the
fixed-point fractional form for the sake of clarity (rather than
scaling them by the factor 10¹ and listing them as integers).

| modulus | $table entries for row {m}_{r} : column i ← \frac{i}{{m}_{r}}$ | | | | | | | | | |
|---|---|---|---|---|---|---|---|---|---|---|
| ↓ mᵣ | 1 | 2 | 3 | 4 | 5 | 6 | 7 | 8 | 9 | 10 |
| 3 → | 0.3 | 0.6 | | | | | | | | |
| 5 → | 0.2 | 0.4 | 0.6 | 0.8 | | | | | | |
| 7 → | 0.1 | 0.2 | 0.4 | 0.5 | 0.7 | 0.8 | | | | |
| 11 → | 0.0 | 0.1 | 0.2 | 0.3 | 0.4 | 0.5 | 0.6 | 0.7 | 0.8 | 0.9 |

Then, the look-up table for the RPPR algorithm is shown in Table 1.

The table consists of 4 subtables (one per-channel/modulus) that are independently accessible in parallel.

For each value of mᵣ, the table consists of a row that simply stores the approximate pre-computed values of the fractions

$$\frac{1}{{m}_{r}} , \frac{2}{{m}_{r}} , … , \frac{{m}_{r} - 1}{{m}_{r}} .$$

§4.2.3.B Further Optimization: Skip the Computation of pᵣ Values

Note that instead of explicitly calculating pᵣ and then using it as an index into a table, the residue zᵣ could be directly used as an index into a table that stores the appropriate values of the precomputed fractions.

$$\frac{{ρ}_{r}}{{m}_{r}} = ( \frac{( ( {w}_{i} \times {z}_{r} ) mod {m}_{r} )}{{m}_{r}} ) \qquad ( 59 )$$

The resulting table is illustrated in Table 2.

In this toy example the number fractional digits required for intermediate computations is 1 which is not a sizable reduction from the full precision which is 3 digits.

The the following non-trivial long-wordlength example demonstrates the truly drastic reduction in precision that is afforded by our novel algorithm.

TABLE 2
Residue Addressed Look-up Table (RAT) for the RPPR algorithm for the
RNS-ARDSP system with [symbol] = {3, 5, 7, 11}. This table is a further optimized
version of Table 1 above: here, the residue value zᵣ is directly used as
the address of a location that stores the corresponding value of
$( \frac{( ( {w}_{i} \times {z}_{r} ) mod {m}_{r} )}{{m}_{r}} )$ in the rth row (i.e., sub-table) for component-
modulus mᵣ. Calculation of ρᵣ is not required when this table is used.

| modulus | $table entries for row {m}_{r} : column i ← \frac{( ( i \times {w}_{i} ) mod {m}_{r}}{{m}_{r}}$ | | | | | | | | | |
|---|---|---|---|---|---|---|---|---|---|---|
| ↓ mᵣ | 1 | 2 | 3 | 4 | 5 | 6 | 7 | 8 | 9 | 10 |
| 3 → | 0.3 | 0.6 | | | | | | | | |
| 5 → | 0.2 | 0.4 | 0.6 | 0.8 | | | | | | |
| 7 → | 0.2 | 0.5 | 0.8 | 0.1 | 0.4 | 0.7 | | | | |
| 11 → | 0.1 | 0.3 | 0.5 | 0.7 | 0.9 | 0.0 | 0.2 | 0.4 | 0.6 | 0.8 |

Note that the only difference between this table and Table 1 is a permutation of the entries in sub-tables for those moduli mᵢ for which the “inner-weights” are larger than unity (in this case wᵢ>1 for the last two rows corresponding to moduli 7 and 11).

§4.2.3.C A Nontrivial Long Word-Length Example

Now consider the partial reconstruction of numbers with a word-length=256 bits. Here the range is R=2²⁵⁶.

In this case, first 44 prime-numbers are required to cover the entire range. Therefore K=44 and [symbol] ={2, 3, 5, 7, 11, . . . , 181, 191, 193}, mₑ=4, and the product of all the component-moduli is [symbol] =198962376391690981640415251545285153602734402721821058212203976095413910572270 and the ratio

$$( \frac{ℳ}{{2}^{256}} ) \approx 1.718$$

mₖ=m₄₄=44 th prime number=193

The word-length required to represent [symbol] is

n=┌log₁₀ ( [symbol] )┐=┌77.298┐=78 decimal digits and the word length required for Z_{T} is (60)

d_{T}=┌log₁₀( [symbol] ×44)┐)=┌78.9┐=79 digits (61)

Hence, any conventional full re-construction method to evaluate [symbol] _{C} requires at least a few operations on 79 digit-long integers.

In contrast, our new partial-reconstruction method requires a drastically smaller precision as well as a drastically small number of simple operations (only additions) to accurately evaluate the reconstruction coefficient [symbol] _{C}. As per Result R1.2 above, the number of fractional digits required in the look-up-tables as well as in intermediate computations is only

w_{F}=┌log₁₀(44×2)┐=2 decimal fractional digits. (62)

When addition of such fractions is considered, the integer part that can accrue requires no more than 2 additional digits (since we are adding at most K=44 values, and each is a proper fraction their sum must be less than 44 and therefore requires no more than 2 decimal digits to store the integer-part).

Therefore, the total number of digits required in all intermediate calculations is as small as 4, which is a drastic reduction from 79. (In general the reduction in precision is from O(lg [symbol] ) required by conventional methods versus the much smaller amount O(lglg [symbol] ) required by our method).

Another extremely important point: by appropriate scaling, all the fixed point fractional values in the table can be converted into integers. Correspondingly, all the fixed-point computations (additions and subtractions of these fractions) are also scaled and can therefore be realized as integer-only operations.

The obvious scaling factor is 10^{w}F. The resulting look-up-table that contains the scaled integers as its entries is illustrated in Table 3.

TABLE 3
The Redsidue Addressed Table RAT for the RPPR algorithm
for the RNS-ARDSP system with first 44 prime numbers
as moduli, i.e., [symbol] = {2, 3, 5, 7, 11, . . . , 191, 193}. The fixed point
truncated values of the fractions are scaled by a factor of Cₛ = 10².

| component modulus | $Table entries for row {m}_{r} : column i ← ⌊ \frac{[ ( ( i \times {w}_{r} ) mod {m}_{r} ) \times {C}_{s} ]}{{m}_{r}} ⌋$ | | | | | | | | | |
|---|---|---|---|---|---|---|---|---|---|---|
| ↓ mᵣ | 1 | 2 | | . . . | | | 189 | 190 | 191 | 192 |
| 2 → | 50 | | | | | | | | | |
| 3 → | 66 | 33 | | | | | | | | |
| | | | . . . | | | | | | | |
| . | | | | . | | | | | | |
| . | | | | . | | | | | | |
| . | | | | . | | | | | | |
| | | | | | . . . | | | | | |
| 191 → | 71 | 42 | | . . . | | | 57 | 28 | | |
| 193 → | 77 | 55 | | | | . . . | | | 44 | 22 |

Note that un-scaling requires a division. But since the scaling factor is a power of the radix of the underlying number representation, un-scaling can be achieved simply by left-shift and truncation of integers. Thus, with the scaling, floating point computations are entirely avoided.

Next we formally specify the algorithm and simultaneously illustrate it for two examples:

1. Example 1: find [symbol] _{C} for value X=641 in the small wordlength case. inputs: X̅=[3, 4, 1, 2] (note that the fully reconstructed value for this touple viz., “641” is not known to the algorithm. It is only given the touple) and the extra-info value (X mod mₑ=1));

2. Example 2: find [symbol] _{C} for the value “X=1” in the long=wordlength case. (inputs: X̅=[1, 1, . . . , 1, 1] and (X mod mₑ=1));

Right below every step of the algorithm, the computations actually performed for each of the two examples are also illustrated inside “comment-blocks”

§4.2.4 Specification of the Algorithm via Maple-Style Pseudo-Code

Algorithm Reduced_Precision_Partial_Reconstruction( Z̅, zₑ)

```
# Inputs: residue-touple Z̅ = [z₁, z₂, . . . , zⱼ], extra-info zₑ = (Z mod mₑ), mₑ ε {2, 4}
# Output: Exact value of the Reconstruction Coefficient [symbol]  _{c}
# Pre-computation : moduli, [symbol] , mₑ, all constants (ex, [symbol]  ⱼ,wⱼ = ((1/ [symbol]  ⱼ) mod mⱼ) mod mⱼ, . . . ))
# create (Reconstruction_Table(s) ) ;
# Step 1: using zᵣ as the indexes, look up ultra low precision estimates \hat{f}ᵣ, r = 1 . . . K
# Note that this can be done in parallel in all channels
nz := 0;
for i from 1 to K do # for each channel i
    if zᵣ = 0 then
        \hat{f}ᵣ := 0;
        n_{z}_{ᵣ} := 1;
    else
        \hat{f} ᵣ := zᵣth element in the look-up-table for mᵣ;
        n_{z}_{ᵣ} := 0;
    f i;  # same as “end if”
od; # same as “end for”
# Example 1: K = 4 values read from Table 1 above (and scaled by the factor Cₛ = 10) = [5, 1, 2, 6]
# Example 2: K = 44 pre-scaled values read from Table 2 above = [50, 61, . . . , 71, 77]
# Step 2: Sum all the \hat{f}ᵣ values with a total of only w_{T} digits of precision to obtain the bounds
```

| | | |
|---|---|---|
| ${\hat{S}}_{low} := {\sum }_{r = 1}^{K} {\hat{f}}_{r} ;$ | ${n}_{z} := {\sum }_{r = 1}^{K} {n}_{{z}_{r}} ; and$ | Ŝ_{high} := Ŝ_{low} + n_{z}; |

# Example 1: Ŝ_{low} = 5 + 1 + 2 + 6 = 14 and Ŝ_{high} = 14 + 4 = 18
# Example 2: Ŝ_{low} = (50 + 61 + . . . + 71 + 77) = 2581 and Ŝ_{high} = 2581 + 44 = 2625
# Step 3: unscale and take the floor of the bounds to obtain integer bounds on [symbol] _{C}
# note that these can be realized as a right-shift followed by truncation

| | |
|---|---|
| ${\hat{I}}_{low} := ⌊ \frac{{\hat{S}}_{low}}{{C}_{s}} ⌋ and$ | ${\hat{I}}_{high} := ⌊ \frac{{\hat{S}}_{high}}{{C}_{s}} ⌋$ |
| $\# Example 1 \text{:} {\hat{I}}_{low} = ⌊ \frac{14}{10} ⌋ = 1 and$ | ${\hat{I}}_{high} = ⌊ \frac{18}{10} ⌋ = 1$ |
| $\# Example 2 \text{:} {\hat{I}}_{low} = ⌊ \frac{2589}{100} ⌋ = 25 and$ | ${\hat{I}}_{high} = ⌊ \frac{2625}{100} ⌋ = 26$ |

```
# Step 4: check if upper & lower integer bounds have same value. if yes, return it as the correct answer
if (Î_{low} == Î_{high}) then
    Return (Î_{low});
fi;
# Example 1: both upper and lower bounds converge to the same value 1 [symbol]  correct value of [symbol]  _{C} = 1, and is returned
# Example 2: Bounds do not converge to the same value [symbol]    need to disambiguate between {25, 26} using extra info
# Step 5: disambiguate using extra-info
if (Z_{T} mod mₑ = {(Î_{low} · [symbol] ) mod mₑ + Z mod mₑ} mod mₑ) then
    Ans := Î_{low};
else
    Ans := Î_{high};
end if ;
# Example 2: it can be verified that: (Z_{T} mod 4) = 1 ≠ ((25 × 2) + 1) mod 4 = 3 mod 4 but
# (Z_{T} mod 4) [symbol]   ((26 × 2) + 1) mod 4 = 1 mod 4
Return (Ans) ; # Output = correct value of [symbol]   _{C}
End_Algorithm
```

The correctness of the algorithm can be proved by invoking Results 1, 2 and other equations and identities presented in this document. In addition, the algorithm has been implemented in Maple (software) and exhaustively verified for small wordlengths (upto 16 bits). A large number of random cases (>10⁵) for long wordlengths (up to 2²⁰≈million-bits) were also run and verified to yield the correct result.

§4.2.5 RPPR Architecture

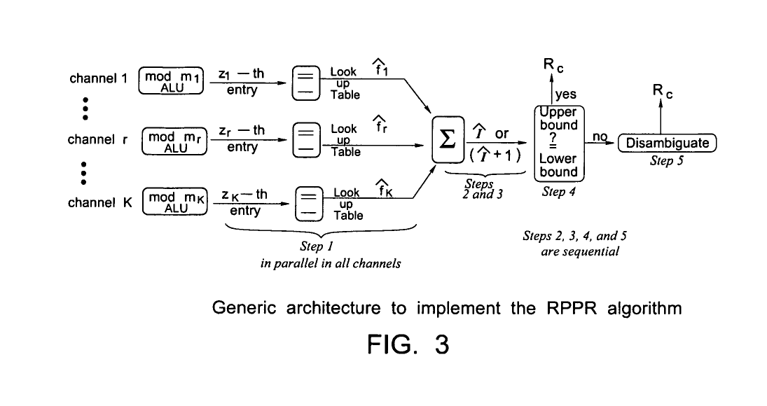

FIG. 3 illustrates the block diagram of an architecture to implement the RPPR algorithm. The main goal of the architecture is to fully leverage the parallelism inherent in the RNS. There are K channels, each capable of performing all basic arithmetic operations, viz., {±, ×, division, shifts, powers, equality-check, comparison, . . . } modulo mᵣ which is the component-modulus value for that particular channel.

In addition, each channel is also capable of accessing it's own look-up-table(s) (independent of other channels). Finally there is a dedicated channel corresponding to the extra modulus mₑ=2 or mₑ=4 that evaluates Z mod mₑ for every non-primary integer Z (non-primary refers to a value that is not an external input or is not one of the precomputed values).

We would like to emphasize that the schematic diagram is independent of whether the actual blocks in it are realized is in hardware or software. The parallelism inherent in the RNS is independent of whether it is realized in h/w or s/w. This should be contrasted with some other speed-up techniques (such as rendering additions/subtractions constant-time by deploying redundant representations) that are applicable only in hardware [40].

§4.2.6 Delay Models and Assumptions

In order to arrive at concrete estimates of delay, we assume a fully dedicated h/w implementation. Each channel has its own integer ALU that can perform all operations modulo any specified modulus. Among all the channels, the K-th one that performs all operations modulo-m_{K} requires the maximum wordlength since m_{K} is the largest component-modulus.

The maximum channel wordlength is: n_{K}=lg m_{K}≈O(lg n)≈lgln [symbol] ≈lglg [symbol] (63)

Note that this is drastically smaller than the wordlength n_{c} required for conventional binary representation, which is roughly O(n), the number of bits required to represent [symbol] .

In accordance with the literature, we make the following assumptions about delays of hardware modules

<A-1> A carry-look-ahead adder can add/subtract two operands within a delay that is logarithmic w.r.t. the wordlength(s) of the operands.

<A-2> Likewise, a fast hardware multiplier (which is essentially a fast multi-operand accumulation tree followed by a fast carry-lookahead-adder and therefore) also requires a delay that is logarithmic w.r.t. the wordlength of the operands.

More generally, a fast-multi-operand addition of K numbers each of which is n-bits long requires a delay of

O(lgK)+O(lg(n+lgK)) which becomes ≈O(lgn) in our case. (64)

<A-3> Assuming that the address-decoder is implemented in the form of a “tree-decoder”, a look-up table with [symbol] entries requires ≈O(lg [symbol] ) delay to access any of it's entries.

<A-4> We assume that dedicated shifter(s) is(are) available. A multi-stage-shifter (also known as a “bar-rel” shifter [1, 6[) implements shift(s) of arbitrary (i.e., variable) number of bit/digit positions, where the delay is ≈O(lg(maximum_shift_distance_in_digits)) units.

§4.2.7 Estimation of the Total Delay

The preceding assumptions, together with Equation (63) imply that the delay Δ_{CH} all operations within individual channels can be approximated to be

Δ_{CH}=lg m_{K}≈O(lglgn)≈lglglg [symbol] (65)

which very small.

The delay estimation is summarized in Table 4.

TABLE 4
ESTIMATION OF THE DELAY REQUIRED BY THE RPPR ALGORITHM

| Algorithm Step no: | | can individual | Approximate Delay | |
|---|---|---|---|---|
| and operation(s) | | channels work | as a function of | |
| performed | | in parallel? | wordlength n | Justification |
| 1: | Compute or look-up ρᵣ values | yes | O(lg lg n) | Equation (65) |
| 2: | Using ρᵣ as the index | yes | O(lg lg n) | Equation (65) |
| | look up estimates \hat{f}ᵣ | | | |
| 3: | Add all the estimates | No | O(lg K) ≈ | Assumption <A-2> |
| | | | O(lg n) | and Equation (64) |
| 4: | Un-scale the sum back | No | O(lg lg n) | realized via a shift and |
| | and truncate | | | truncation |
| 5: | Check if upper and lower bounds | No | O(1) | obvious, equality check |
| | converge to the same value | | | on small values |
| 6: | Disambiguation | No | O(lg lg n) | mₑ ε {2,4} [symbol] |
| | | | | tiny operands |

| | | |
|---|---|---|
| Overall delay ≡ Latency | O(lg n) | dominant “functional” |
| | | component |

As seen in the table, the dominant delay is in Step 3, the accumulation of values read from the per-channel look-up tables.

Therefore, the overall delay is ≈O(lgn) ≈O(lglg [symbol] )

§4.2.8 Memory Required by the PR Algorithm

The r-th channel associated with modulus mᵣ has its own Look-up table with (mᵣ−1) entries (since the case where the remainder is “0” need not be stored). Hence, the number of storage locations needed is

$${\sum }_{r = 1}^{K} ( {m}_{r} - 1 ) < K \cdot {m}_{K} \approx O ( {K}^{2} ) \approx O ( {n}^{2} ) \qquad ( 66 )$$

Each location stores a fractional value that is no longer than w_{F} digits ≈O(lgn) bits. Therefore, total storage (in bits)=O(n²) (locations)×O(lgn) (bits per locations) ≈O(n²lgn) bits (67)

There are several important points to note:

1 [symbol] Although the above estimate makes it look as-though it is a single chunk of memory, in reality it is not. Realize that each channel has its own memory that is independently accessible. The implications are:

2 [symbol] The address-selector (aka the decoder) circuitry is substantially smaller and therefore faster (than if the memory were to be one single block).

3 [symbol] It is a READ-ONLY memory, the precomputed values are to be loaded only once, they never need to be written again. In a dedicated VLSI implementation, it would therefore be possible to utilize highly optimized, smaller and faster cells.

§4.3 Base Change/Extension

Those familiar with the art will realize that once the “RPPR” algorithm yields an exact equality for the operand (being partially re-constructed), a base-extension or change is straightforward.

Without loss of generality, the algorithm is illustrated via an example which extends a randomly generated 32-bit long unsigned integer to a 64-bit integer (without changing the value), which requires an extension of the residue touple as shown below.

In order to cover the (single-precision) range ┌0, 2³²┐, the moduli set required is [symbol] = [symbol] ₃₂={2,3,5,7,11,13,17,19,23,29} so that K=| [symbol] |=10, and total product [symbol] =6469693230, the reconstruction weights are

$${ℳ}_{i} = \frac{{m}_{i}}{} ,$$

i=1, . . . , 10 =[3234846615, 2156564410, 1293938646, 924241890, 588153930, 497668710, 380570190, 340510170, 281291010, 223092870] and the inner weights are

$${w}_{i} = ( \frac{1}{{i}_{}} ) mod {m}_{i} ,$$

i =1, . . . , 10 =[1,1,1,3,1,11,4,9,11,12]

In order to cover the double-precision range [0, 2⁶⁴], the extended moduli set required is [symbol] ₑₓₜ= [symbol] ₆₄={2,3,5,7,11,13,17,19,23,29,31,37,41,43,47,53} so that Kₑₓₜ= [symbol] ₑₓₜ|=16, and total product [symbol] ₑₓₜ=32589158477190044730

Let the single precision operand be Z=1355576195≡ Z̅=[1,2,0,1,6,12,3,10,10,21] and zₑ=Z mod 4=3. The CRT expresses the value Z in the form

Z=(3234846615×p₁+2156564410×p₂+ . . . +223092870×p₁₀)−6469693230 [symbol] _{C}_{_{z}} (68)

where, pᵢ=(zᵢ×wᵢ) mod mᵢ is the reconstruction remainder for channel i, for i=1, . . . , 10 and [symbol] _{C}_{_{z}}=the reconstruction coefficient for Z

The only unknown in Eqn (68) is [symbol] _{C}_{_{z}} which can be determined using the “RPPR” algorithm yielding an exact integer equality, enabling a straightforward evaluation of the extra-residues needed to extend the residue touple. For example the first extra-modulus in the example at hand is m₁₁=31. Accordingly, Z̅ₑₓₜ[11]=z₁₁=(Z mod 31)

Note that (3234846615 mod 31), . . . , (6469693230 mod 31) are all constants for a given RNS and can be pre-calculated and stored. In general we always assume that whichever values can be pre-computed are actually pre-computed. Thus

θ_{(i,j )}= [symbol] ᵢ mod mₑⱼ for i=1, . . . , K and j=K+1, . . . , Kₑₓₜ (69)

are all pre-computed and stored, so that the operation of evaluating the remainder w.r.t. an extra modulus mₑ_{ᵣ} in the extended RNS system (such as the modulus 31 in the running example at hand) simplifies to

Z mod mₑ_{ᵣ}=(θ_{(1,e}_{ᵣ}₎p₁+ƒ_{(2,e}_{ᵣ}₎p₂+ . . . +θ_{(K,e}_{ᵣ})p_{K}−Δₑ_{ᵣ} [symbol] _{C}_{_{z}})mod mₑ_{ᵣ} (70)

where, Δₑ_{ᵣ}= [symbol] mod mₑ_{ᵣ}

Next, we specify the algorithm exactly in Maple-style pseudo-code.

§4.3.1 Specification of the Algorithm via Maple-Style Pseudo-Code

```
Algorithm Base_extension_using_RPPR_method( Z̅,zₑ)
/* Inputs : residue-touple Z̅ = [z₁,z₂,...,z_{K}], extra-info zₑ =
(Z mod mₑ), mₑ = 4
    corresponding to a 32 bit unsigned integer Z */
# Output: residue touple for the 64-bit extension of Z
/* Pre-computation : original moduli-set [symbol] ₃₂ = {2,3,...,29},
| [symbol] ₃₂| = K₃₂ = 10
    extended moduli-set [symbol]  ₆₄ = {2,3,...,53}, | [symbol] ₆₄| = K₆₄ = 16
    all constants (ex, [symbol]  ⱼ,wⱼ = ( (1/ [symbol] ⱼ) mod mⱼ,...))
    Reconstruction_Table(s) for both [symbol] ₃₂ and [symbol] ₆₄, etc. */
# Step 1: evaluate [symbol]  _{C}_{_{z}} using the “RPPR” algorithm [symbol]
_{C}_{_{z}} = Reduced_Precision_Partial_Reconstruction( Z̅,zₑ) ;
# Step 2: evaluate the extra residues as per Eqns (68) and (70)
# This can be executed in parallel in all channels corresponding to the
extension moduli
for i from 1 to Kₑ do # in each extension channel i
    sum := 0;
    for j from 1 to Kₑ do
      sum := sum + ρⱼ × θ_{i,j} ;
    od;
    zᵢ := (sum − Δᵢ [symbol] _{C}_{_{z}} ) mod mᵢ ;
    Z̅:= concat( Z̅, zᵢ) ; # append the new residue to the
    residue touple
od ;
Return ( Z̅) □
End_Algorithm
```

§4.4 Sign and Overflow Detection by Interval Separation (SODIS)

The next canonical operation I have sped-up is sign-detection. The new algorithms for sign-detection in the RNS are illustrated in this section.

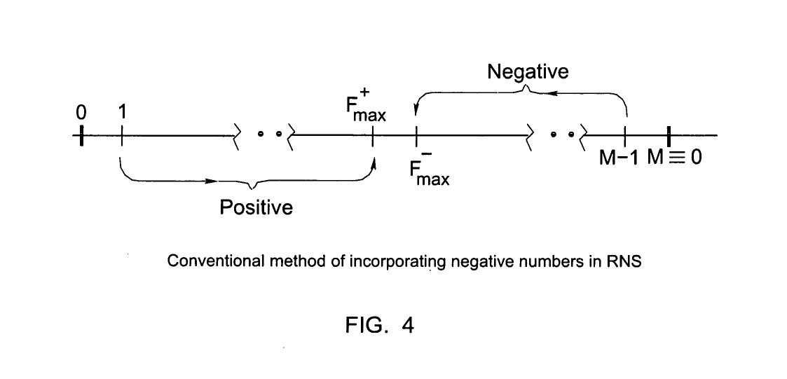

As illustrated in FIG. 4, fundamentally, the RNS representation does allow a separation of positive and negative integers into distinct non-overlapping regions (what is meant here is that the RNS mapping is not so strange as to “mix” positive and negative numbers throughout the entire range. It takes an “interval” (namely the interval including all negative integers) and faithfully (i.e., without changing the length of the interval) simply translates (or displaces) it into another another “interval” which is not surprising since the “mapping” corresponding to the translation is the simple first degree equation describing the “modulo” operation, i.e., Eqn. (3))

Q: Where then is the problem in sign detection?

A: (i) Note that a “re-construction” of the overall magnitude is necessary
(ii) For the efficiency of representation (i.e., in order not to waste capacity) the following additional constraint is also imposed in most RNS implementations.

Fₘₐₓ⁻=Fₘₐₓ⁺+1 (71)

In other words, ALL the unsigned integers in the range [0, [symbol] −1] are utilized, not a single digit value is wasted.

An unfortunate by-product of this quest for representational efficiency is that consecutive integers Fₘₐₓ⁺ and Fₘₐₓ⁻ end up having opposite signs. Consequently, re-construction must be able to distinguish between consecutive integers, i.e., the resolution of the re-construction must be full, i.e., in fractional computations

$$ulp < \frac{1}{} \qquad ( 72 )$$

This, in-turn requires that all fractional computations must be carried out to the full precision, thereby rendering them slow.

The main question therefore is whether it is possible to make do with the drastically reduced precision we wish to deploy? and if so, then how?

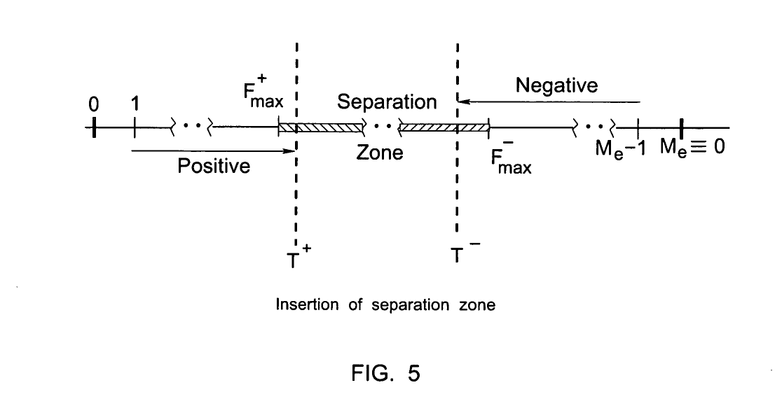

The answer is to insert a sufficiently large “separation-zone” between the positive and negative regions, as illustrated in FIG. 5.

In FIG. 5, note that

both “0” as well as [symbol] ₑ correspond to the actual magnitude 0 (73)

unsigned integers {1, . . . , Fₘₐₓ⁺} represent +ve values and (74)

unsigned integers {Fₘₐₓ⁻, . . . , ( [symbol] ₑ−1)} represent −ve values {−( [symbol] ₑ−Fₘₐₓ⁻), . . . , −1}, repsectively, wherein (75)

Unsigned Integer Fₘₐₓ⁺ represents the maximum positive magnitude allowed, and (76)

Unsigned Integer Fₘₐₓ⁻ represents the max. −ve magnitude allowed=( [symbol] ₑ−Fₘₐₓ⁻) (77)

The interval between Fₘₐₓ⁺ and Fₘₐₓ⁻ is the separation zone (78)

Most practical/useful number representations try to equalize the number of +ve values and the number of −ve values included in order to attain maximal amount of symmetry. This yields the constraint

Fₘₐₓ⁻≈ [symbol] ₑ−Fₘₐₓ⁺ (79)

Intuitively, it is clear that equal lengths should be allocated to

(1) the +ve interval

(2) the −ve interval and

(3) the separation-zone between the opposite polarity intervals.

For this to be possible, the extended modulus [symbol] ₑ must satisfy [symbol] ₑ>3·Fₘₐₓ⁺ (80)

Finally, the attainment of maximal possible symmetry dictates that to the extent possible, the separation-zone must be symmetrically split across the mid-point of the range [0, ( [symbol] ₑ−1)]. Note that FIG. 5 incorporates all these symmetries.

With the separation interval in place, note that all +ve numbers Z⁺ within the range [1,Fₘₐₓ⁺] when represented as fractions of the total magnitude [symbol] ₑ now satisfy

$$0 < \frac{Z +}{{e}_{}} < \frac{1}{3} \qquad ( 81 )$$

Likewise, all −ve numbers Z⁻ when represented as fractions of the total magnitude Mₑ satisfy

$$\frac{2}{3} < \frac{{Z}^{-}}{{e}_{}} < 1 \qquad ( 82 )$$

But Eqn (19) (repeated here for the sake of convenience) states that

$$\frac{Z}{} = ( S - ⌊ S ⌋ ) = the fractional part of the sum of fractions \approx {\sum }_{r = 1}^{K} \hat{{f}_{r}} \qquad ( 83 )$$

In other words, the separation interval enables the evaluation of the sign of the operand under consideration by examining one (or at most two) most significant digits of the accumulated sum of fractions.

Recall that in the partial reconstruction, the integer part of the sum-of-fractions was of crucial importance.

It is quite striking that when the interval separation is properly leveraged as illustrated herein, the most significant digit(s) of the fractional part also convey equally valuable information, viz., the sign of the operand.

As per Equations (81) and (82) the natural choice of the detection boundaries T⁺ and T⁻ is specified by the relations

$$\begin{matrix}\frac{{T}^{+}}{{e}_{}} = \frac{1}{3} = 0.333 … and & ( 84 ) \\ \frac{{T}^{-}}{{e}_{}} = \frac{2}{3} = 0.666 … & ( 85 )\end{matrix}$$

However, note that even if the “detection boundaries” T⁺(for +ve numbers) and T⁻(for −ve numbers) are moved slightly into the “separation zone”, as illustrated in FIG. 5, the sign-detection outcome does not change.

For the ease of computation, we therefore set

$$\begin{matrix}\frac{{T}^{+}}{{e}_{}} = \frac{4}{10} = 0.4 and & ( 86 ) \\ \frac{{T}^{-}}{{e}_{}} = \frac{6}{10} = 0.6 & ( 87 )\end{matrix}$$

§4.4.1 Specification of Sign-Detection Algorithm via Maple-Style Pseudo-Code

Algorithm Eval_Sign ( Z̅, zₑ)

```
# Input(s): Given an integer Z represented by the residue touple/vector Z̅ := [z₁, . . . , z_{K}]
# and one extra value, viz., zₑ = (Z mod mₑ) where mₑ = 4
/* Output(s): the Sign of Z, defined as
$Sign ( Z ) = \{ \begin{matrix}0 & if Z = 0 \\ + 1 & if Z > 0 \\ - 1 & otherwise\end{matrix} \qquad ( 88 )$
The algorithm also returns two more values in addition to the sign
(i) the value of the reconstruction coefficient [symbol]  _{C} for the input and
(ii) Approx_overflow_estimate which is a flag defined as follows:
$Approx\_overflow \_estimate = \{ \begin{matrix}1 & if overflow is detected for sure \\ 0 & otherwise\end{matrix} \qquad ( 89 )$
further computation is needed to determine whether there is an overflow in the 2nd case above
Pre-computation: Everything needed for the “RPPR” algorithm, and in addition
Fₘₐₓ⁺, Fₘₐₓ⁻, decision boundaries T⁺ and T⁻, etc. */
# Step 1: Look up pre-stored estimates fᵣ, r = 1 . . . K
for i from 1 to K do # for each channel i
    if zᵣ = 0 then
        \hat{f}ᵣ := 0;
        n_{z}_{ᵣ} := 1;
    else
        \hat{f}ᵣ := zᵣ-th element in the look-up-table for mᵣ;
        n_{z}_{ᵣ} := 0;
    end if
od;
# Step 2: Sum all the fᵣ values with only w_{T} total digits
```

| | |
|---|---|
| ${\hat{S}}_{low} := {\sum }_{r = 1}^{K} {\hat{f}}_{r} ;$ | ${n}_{z} := {\sum }_{r = 1}^{K} {n}_{{z}_{r}} ; and {\hat{S}}_{high} := {\hat{S}}_{low} + {n}_{z} ;$ |

if (n_{z} == K) then # all components = 0 [symbol] Z = 0
Return(0, 0, 0);
fi;
# Step 3: unscale and separate integer and fractional parts

| | |
|---|---|
| ${\hat{I}}_{low} := ⌊ \frac{{\hat{S}}_{low}}{{C}_{s}} ⌋ ; {\hat{F}}_{low} := ( {\hat{S}}_{low} - {\hat{I}}_{low} ) ; and$ | ${\hat{I}}_{high} := ⌊ \frac{{\hat{S}}_{high}}{{C}_{s}} ⌋ ; {\hat{F}}_{high} := ( {\hat{S}}_{high} - {\hat{I}}_{high} ) ;$ |

```
# important substitutions
\hat{F} = \hat{F}_{low}; and Î = Î_{low};
# Step 4: determine the temporary sign
Approx_overflow_estimate := 0;
if (\hat{F} < T⁺) then
    Temp_Sign := +1;
else if (\hat{F} > T⁻) then
    Temp_Sign := −1;
else
    Approx_overflow_estimate := 1;
    if (\hat{F} < 1/2) then
        Temp_Sign := +1;
    else
        Temp_Sign := −1;
    end if;
end if;
# Step 5: determine [symbol] _{C}
if (Î_{high} = Î_{low}) then [symbol]
    _{C} := Î
else
    if (Z_{T} mod 4 = {(Î · [symbol] ) mod 4 + Z mod 4} mod 4) then [symbol]
        _{C} := Î;
    else [symbol]
        _{C} := Î + 1;
    fi;
fi;
if ( [symbol] _{C} , = Î) then
    Sign := Temp_Sign;
else
    Sign := (−1) × Temp_Sign;
fi;
Return(Sign, [symbol] _{C}, Approx_overflow_estimate)
End_Algorithm
```

§ 4.4.2 Overflow Detection

Since we are dealing with sign-detection of integers, an underflow of “magnitude” simply results in the value “0”; no other action needs to be taken in case of magnitude underflow.

However, a magnitude overflow, must be detected and flagged. let A and B be the operands and let [symbol] denote some operation, then “overflow of magnitude” includes both cases

case 1: (A [symbol] B)>Posedge=Fₘₐₓ⁺ and (90)

case 2: (A [symbol] B)<Negedge=−( [symbol] −Fₘₐₓ⁻) or dividing both sides by [symbol] (91)

$$\begin{matrix}\frac{( A ⊗ B )}{} > \frac{{F}_{ma x}^{+}}{} and & ( 92 ) \\ \frac{( A ⊗ B )}{} < \frac{{F}_{ma x}^{-}}{} & ( 93 )\end{matrix}$$

However, recall that the decision boundaries T⁺ and T⁻ are shifted by a small amount into the “separation region”. As a result, whenever input values in the range [Fₘₐₓ⁺,T⁺] or in the range [T, Fₘₐₓ] are encountered, they will be wrongly classified as being within the correct range even though they are actually outside the designated range. The only solution to this problem is to separately evaluate the sign of either (Z−Fₘₐₓ⁺) or (Z−Fₘₐₓ⁻) to explicitly check for overflow.

§4.4.2.A Specification of Overflow Detection Algorithm via Maple-Style Pseudo-Code

Algorithm Eval_overflow( Z̅, zₑ, Sign, approx_overflow)

```
# Note that every invocation of this algorithm must be immediately preceded by
# an invocation of the Eval_sign algorithm
/* Precomputations: same as those for algorithm Eval_sign
Inputs: Z̅, zₑ, Sign of Z, approx_overflow for Z
The last two values are obtained as a result of the execution of the
Eval_sign algorithm immediately preceding the invocation of this algorithm.
Output(s): overflow flag defined as
$overflow = \{ \begin{matrix}1 & if overflow is detected for sure \\ 0 & no overflow\end{matrix} \qquad ( 94 )$
    */
# Step 1: handle the trivial cases first
if (Sign == 0) then
    Return(0);
fi;
if (approx_overflow == 1) then
    Return(1);
fi;
# Step 2: Determine the argument “TZ” for auxiliary sign-detection.
# note that the residue touple T̅Z̅ corresponding to the integer TZ is directly determined
# via component-wise subtractions in the Residue Domain
if (Sign == +1) then
    T̅Z̅ := Z̅ ⊖ F̅ₘ̅ₐ̅ₓ̅⁺̅;  # ⊖ denotes component-wise subtraction in the residue domain
tzₑ := (zₑ − (Fₘₐₓ⁺mod 4)) mod 4;  # disambiguation-bootstrapping
else if (Sign == −1) then
    T̅Z̅ := Z̅ ⊖ F̅ₘ̅ₐ̅ₓ̅⁻̅;
    tzₑ := (zₑ − (Fₘₐₓ⁺mod 4)) mod 4;  # keep track of all values modulo 4
end if ;
# Step 3: determine the sign of TZ, (which is denoted by the variable S_{tz} herein
S_{tz}, tmp_rc, approx_overflow_tz := Eval_sign( T̅Z̅, tzₑ);
if (Sign == +1) then
    if (S_{tz} == +1) then
        overflow := 1;
    else
        Overflow := 0;
    end if;
else if (Sign == −1) then
    if (S_{tz} == −1) then
        Overflow := 1;
    else
        Overflow := 0;
    end if;
end if;
Return (overflow);
End_Algorithm
```

Once these building blocks are specified, the overall SODIS algorithm is specified next.

§4.4.2.B Specification of Sign and Overflow Detection Algorithm via Maple-Style Pseudo-Code

Algorithm Sign_and_Overflow_Detection_by_Interval_Sepation( Z̅,
zₑ)
# this algorithm is abbreviated as “SODIS”
# Inputs: Z̅, zₑ
# Outputs: Sign (Z), overflow, [symbol] _{C}_{_{z}}
Sign, [symbol] R_{C}_{_{z}} , approx_overflow := Eval_sign ( Z̅, zₑ) ;
overflow := Eval_overflow( Z̅, zₑ, Sign, approx_overflow) ;
Return(Sign, overflow, [symbol] _{C}_{_{z}} ) ; □
End_Algorithm

Those familiar with the art shall realize that using the algorithms presented in this section, a comparison of of two numbers say A and B can be realized extremely fast, without ever leaving the residue domain in a straightforward manner by detecting the sign of (A-B).

§4.5 The Quotient First Scaling (QFS) Algorithm for Dividing by a Constant

Assume that a double-length (i.e., 2n-bit) dividend X is to be divided by an n-bit divisor D, which is a constant, i.e., it is known ahead of time. The double length value X is variable/dynamic. It is either an external input or more typically it the result of a squaring or a multiplication of two n-bit integers. It is assumed that the extra-bit of information, i.e., the value of (X mod mₑ) is available. Given positive integers X and D, a division entails computing the quotient Q and a remainder R such that

$$X = Q \times D + R where 0 \leq R < D so that Q = ⌊ \frac{X}{D} ⌋ \qquad ( 95 )$$

To derive the Division algorithm, start with the alternative form of the Chinese Remainder Theorem (CRT) which expresses the target integer via an exact integer equality of the form illustrated in Equations (B-8.*). Express the double-length Dividend X as

$$X = {X}_{T} - \cdot {{C}_{x}}_{} = ( {\sum }_{r = 1}^{K} {ℳ}_{r} \cdot {ρ}_{r} ) - \cdot {{C}_{x}}_{} \qquad ( 96 )$$

where the exact value of Reconstruction Coefficient [symbol] _{C}_{ₓ} is determined using the “RPPR” algorithm explained in Section 4.2 above. In other words, there is no unknown in the above exact integer equality expressing the value of the dividend X.

To implement Division, evaluate the quotient Q as follows:

$$\begin{matrix} \begin{matrix}Q = ⌊ \frac{X}{D} ⌋ \\ = ⌊ {\sum }_{r = 1}^{K} \frac{{ℳ}_{r } \cdot {ρ}_{r}}{D} - \frac{{{C}_{x}}_{} \cdot }{D} ⌋ \\ = ⌊ \{ {\sum }_{r = 1}^{K} ( {Q}_{r} + \frac{{R}_{r}}{D} ) \} - ( {Q}_{RC} + \frac{{R}_{RC}}{D} ) ⌋\end{matrix} & ( 97 ) \\ = ⌊ \{ {\sum }_{r = 1}^{K} ( {Q}_{r} + {f}_{r} ) \} - ( {Q}_{RC} + {f}_{RC} ) ⌋ where & ( 98 ) \\ {Q}_{r} , {Q}_{RC} = ⌊ \frac{{ℳ}_{r} \cdot {ρ}_{r}}{D} ⌋ , \\ ⌊ \frac{{{C}_{x}}_{} \cdot }{D} ⌋ = precomputed quotient values , and & ( 99 ) \\ {R}_{r} , {R}_{RC} = ( {ℳ}_{r} \cdot {ρ}_{r} - {Q}_{r} \cdot D ) , \\ ( {{C}_{x}}_{} \cdot - {Q}_{RC} \cdot D ) = precomputed remainders , and & ( 100 ) \\ {f}_{r} , {f}_{RC} = \frac{{R}_{r}}{D} , \\ \frac{{R}_{RC}}{D} = remainders expressed as fractions of the divisor D & ( 101 )\end{matrix}$$

The exact integer-quotient can be written as

$$\begin{matrix}Q = ( {\sum }_{r = 1}^{K} {Q}_{r} ) - {Q}_{RC} + ⌊ ( {\sum }_{r = 1}^{K} {f}_{r} ) - {f}_{RC} ⌋ = {Q}_{I} + {Q}_{f} where & ( 102 ) \\ {Q}_{I} = ( {\sum }_{r = 1}^{K} {Q}_{r} ) - {Q}_{RC} = the contribution of Integer \text{-} part , \\ ( hence the subscript {}_{}^{″}{I}{}_{}^{″} ) , and & ( 103 ) \\ {Q}_{f} = ⌊ ( {\sum }_{r = 1}^{K} {f}_{r} ) - {f}_{RC} ⌋ = the contribution of fractional \text{-} part \\ ( hence the subscript {}_{}^{″}{f}{}_{}^{″} ) & ( 104 )\end{matrix}$$

Since exact values of Qᵣ and Q_{RC} are pre-computed and looked-up, the value of Q_{I} in Eqn (103) above is exact. However, since we use approximate precomputed values of the fractions truncated to drastically small precision, the value of Q_{f} calculated via Eqn (104) above is approximate. As a result, the value of Q that is calculated is also approximate. We indicate approximate estimates by a hat on top, which yields the relations:

$$\begin{matrix}\hat{Q} = {Q}_{I} + \hat{{Q}_{f}} where & ( 105 ) \\ \hat{{Q}_{f}} = ⌊ ( {\sum }_{r = 1}^{K} \hat{{f}_{r}} ) - \hat{{f}_{RC}} ⌋ & ( 106 )\end{matrix}$$

Our selection of moduli (explained in detail in Section 4.1 above) leads to the fact that the number of of memory-locations required for an exhaustive look-up turns out to be a small degree (quadratic) polynomial of n=lg [symbol] . This amount of memory can be easily integrated in h/w modules in today's technology for word-lengths up to about 2¹⁷≈0.1-Million bits (which should cover all word-lengths of interest today as well as in the foreseeable future).

Note that the Reconstruction Coefficient [symbol] _{C}_{ₓ} can also assume only a small number of values (no more than (K-1) where K is the number of moduli as per Eqns (B-4, B-5) and (B-9) Hence, quotient values Q_{RC} and the fractions

$${f}_{RC} = ( \frac{{R}_{RC}}{D} )$$

can also be pre-computed and stored for all possible values the Reconstruction Coefficient [symbol] _{C}_{ₓ} can assume.

§4.5.1 Further Novel Optimizations

\textcircled{1} Store the pre-computed Quotient values directly as residue touples

Note that the quotient values themselves could be very large (about the same word-length as the divisor D). However, we need not store these long-strings of quotient values, since in many applications (such as modular exponentiation) the quotient is only an intermediate variable required to calculate the remainder. Obviously the extra bit of information conveyed by (Qᵣₛ mod mₑ) is also pre-computed and stored together with the touple representing the exact integer quotient

$${Q}_{ir} = ⌊ \frac{r \cdot {ℳ}_{i}}{D} ⌋ for i = 1 , … , K and r = 1 , … , ( {m}_{r} - 1 ) \qquad ( 107 )$$

The total memory required to store either the full-length long-integer value or storing the residues w.r.t. the component moduli as a touple is about the same. By opting to store only the residue-touples, we eliminate the delay required to convert integer quotient values into residues, without impacting the memory requirements significantly.
\textcircled{2} Only fractional remainders truncated to drastically reduced precision O(lgK)≈O(lglg [symbol] ) need to be pre-computed and stored (exactly similar to the “RPPR” algorithm).
\textcircled{3} simple scaling converts all fractional storage/computations into integer values.

Thus, the QFS algorithm needs 2 distinct Quotient_Tables.

§4.5.2 Quotient-Tables Explained via a Small Numerical Example

I believe that the tables can be best illustrated by a concrete-small example. Assume that the divisor D=209=11×19 (i.e. D is representable as an 8-bit number). The dividends of interest are therefore up-to 16-bit long numbers. In this case the moduli turn out to be [2, 3, 5, 7, 11, 13, 17]. Even if the first two moduli (viz., 2 and 3) are dropped, the product still exceeds the desired range [0, 2¹⁶]. Therefore we select

[symbol]

={5,7,11,13,17} [symbol] K=5, [symbol] =85085 and the extra-modulus mₑ=2 (108)

To realize division by this divisor D=209, the first table required is shown in Table 5.

This table is referred to as “Quotient_Table_{—}1” (or also as the “Quotient_Touples_Table”). It stores all possible values of Quotients required to evaluate the first term (the sum) in Eqn (103). The entries (rows) corresponding to each component-modulus mᵣ constitute a sub-table of all possible values pᵣ can assume for that value of mᵣ. For the sake of clarity, we have used a “double-line” to separate one sub-table from the next.

To illustrate the pre-computations, we explain the last sub-table, in Quotient_Table_{—}1 corresponding to the component-modulus “m₅=17”, wherein,

$${ℳ}_{17} = \frac{17}{} = 5005.$$

This sub-table has 16 rows. The first row corresponds to p₅=1 the second row corresponds to p₅=2 and so on. Now, we explain each entry in the penultimate row in Table 1 above (this row corresponds to p₅=15).

The value in the 3rd column titled “Quotient . . . ” lists the quotient, i.e.

$$⌊ \frac{{ℳ}_{17} \times 15}{D} = \frac{5005 \cdot 15}{209} ⌋ = 359.$$

The next entry (within the angled-brackets [symbol] [symbol] ) simply lists the value of (Q₅_{_{—}}₁₅ mod mₑ)=(359 mod 2)=1. The 4th column stores the residue-touple [4,2,7,8,2] representing the quotient 359.

The last column in Table 1 stores the fixed point fractional remainder values scaled by the multiplying factor b^{w}^{_{f}}=10² to convert them into integers. For instance, in the penultimate row: the actual remainder is (5005×15−359×209)=44, corresponding fractional remainder is

$$\frac{44}{209} \approx 0.21052 …$$

which when truncated to two decimal places yields 0.21

Accordingly,

$$trunc ( \frac{44}{209} \times {10}^{2} ) = 21$$

and this is the value stored in the last column.

TABLE 5
Quotient_Table_1 for RNS-ARDSP with moduli [symbol] = [5, 7, 11, 13, 17] and divisor D = 209. In
this case, two digits suffice to store the scaled fractional-remainders in the last column.

| modulus mᵣ ↓ | ρᵣ = [1, 2, . . . mᵣ − 1] ↓ | Quotient ${Q}_{r} = ⌊ \frac{{M}_{r} \cdot {ρ}_{r}}{D} ⌋$ and [symbol] Qᵣ mod 2 [symbol] | moduli mⱼ, j = 1 . . . K [5, 7, 11, 13, 17] Qᵣ mod mⱼ, j = 1 . . . K | Remainder Rᵣ = Mᵣ · ρᵣ − Qᵣ · D Scaled Fractional Rem = $trunc ( \frac{{R}_{r}}{D} \times {10}^{{w}_{f}} ) ↓$ |
|---|---|---|---|---|
| 5 | 1 | 81 [symbol] 1 [symbol] | [1, 4, 4, 3, 13] | 42 |
| | 2 | 162 [symbol] 0 [symbol] | [2, 1, 8, 6, 9] | 84 |
| | 3 | 244 [symbol] 0 [symbol] | [4, 6, 2, 10, 6] | 26 |
| | 4 | 325 [symbol] 1 [symbol] | [0, 3, 6, 0, 2] | 68 |
| . | | | | |
| . | | | | |
| . | | | | |
| | | | . . . | |
| | | | | . |
| | | | | . |
| | | | | . |
| 17 | 1 | 23 [symbol] 1 [symbol] | [3, 2, 1, 10, 6] | 94 |
| | 2 | 47 [symbol] 1 [symbol] | [2, 5, 3, 8, 13] | 89 |
| | . | | | |
| | . | | | |
| | . | | | |
| | 15 | 359 [symbol] 1 [symbol] | [4, 2, 7, 8, 2] | 21 |
| | 16 | 383 [symbol] 1 [symbol] | [3, 5, 9, 6, 9] | 15 |

We would like to point out that the actual full-wordlength-long integer values of quotients Qᵣ (that are listed in column 3 in the table) need not be (and hence are not) stored in a real (h/w or s/w) implementation of the algorithm (the full decimal Qᵣ values were included in column 3 in Table 1 above, merely for the sake of illustration). In an actual implementation, only the extra-information, i.e., [symbol] Qᵣ mod 2 [symbol] values (shown inside the angled-braces [symbol] [symbol] in column3) and the residue-domain touples representing Qᵣ (as shown in column 4 in the table) are stored. For example, in the penultimate row, actual quotient value “359” need not be stored, only [symbol] 359 mod 2 [symbol] = [symbol] 1 [symbol] would be stored, together with the touple of residues of 359 w.r.t. the component moduli=[359 mod 5, . . . , 359 mod 17]=[4, 2, 7, 8, 2] as shown in column 4 therein.

Next we explain Table 6, which shows Quotient_Table_{—}2 (also referred to as the “Quotient_Rc_Table”)

TABLE 6
Quotient_Table_2 for RNS-ARDSP with moduli [5,7,11, 13, 17] and divisor D = 209.

| [symbol] _{C} = [1, 2, . . . K] ↓ | Quotient ${Q}_{c} = ⌊ \frac{M \cdot {R}_{C}}{D} ⌋$ [symbol] Q_{c} mod 2 [symbol] | moduli mⱼ, j = 1 . . . K [5, 7, 11, 13, 17] Q_{c} mod mⱼ, j = 1 . . . K | Remainder R_{c} = [symbol] · [symbol] _{C} − Q_{c} · D Scaled Fractional Remainder $Scaled Fractional Rem = ceil ( \frac{{R}_{c}}{D} \times {10}^{{w}_{f}} ) ↓$ |
|---|---|---|---|
| 1 | 407 [symbol] 1 [symbol] | [2, 1, 0, 4, 16] | 11 |
| 2 | 814 [symbol] 0 [symbol] | [4, 2, 0, 8, 15] | 22 |
| 3 | 1221 [symbol] 1 [symbol] | [1, 3, 0, 12, 14] | 32 |
| 4 | 1628 [symbol] 0 [symbol] | [3, 4, 0, 3, 13] | 43 |
| 5 | 2035 [symbol] 1 [symbol] | [0, 5, 0, 7, 12] | 53 |

This table covers all possible values of the Reconstruction Coefficient [symbol] _{C}_{ₓ} in Eqns (96)-(98). Like Table 5, the values in column 2 (i.e., the full-wordlength-long integer values of quotient Q_{c}) are not stored in actual implementation, (they are included in the table only for the sake of illustration). In actual implementations, only the residues of Q_{c} with respect to (w.r.t.) 2 (shown inside angled braces [symbol] [symbol] in column 2) and the touple of residues of Q_{c} w.r.t. the component-moduli are stored as illustrated in the third column of the Table. The last column stores the fixed point fractional remainder values scaled by the factor 10^{w}^{_{f}} to convert them into integers.

Another nontrivial distinction of Quotient_Table_{—}2 from all previous tables is the fact that the fractional values in the last column are always rounded-up (the mathematical expression uses the “ceiling” function). Note that the last term in Equations (96) and (98), has a negative sign. As a result, when rounding the fractional remainders, we must “over-estimate” them, so that when this value is subtracted to obtain the final quotient estimate, we never over-estimate. In other words, the use of “ceiling” function is necessary to ensure that we are always “under-estimating” the total quotient.

§4.5.3 Specification (Pseudo-Code) of the QFS Algorithm

Like the RPPR-algorithm, we illustrate the division algorithm with 2 examples:

(i) first with small sized operands (dividend X=3249, divisor D=209) so that the reader can replicate the calculations by hand/calculator if needed.

(ii) The 2nd numerical example is a realistic long-wordlength case.

Instead of separating the pseudo-code and numerical illustration, we have waved in the numerical illustration of each step of the algorithm for the running (small) example at hand by including the numerical calculations into the pseudo code as comment blocks.

Algorithm Quotient_First_Scaling_Estimate ( X̅, [symbol] X mod mₑ) [symbol] )

# Inputs: Dividend X as a residue-touple ( X̅ = [x₁, . . . , x_{K}] and [symbol] X mod mₑ [symbol] ), where mₑ ε {2, 4}
# Pre-computations: Moduli, extra_modulus mₑ, all constants [symbol] ,Mᵣ, wᵣ, r = 1, 2, . . . , K etc.
create (Reconstruction_Tables); create (Quotient_Tables);
# Step 1: use the RPPR-algorithm to find the Reconstruction-(Remainders & Coefficient) for X

| | |
|---|---|
| (1.1) | [ρ₁, . . . ,ρ_{K}], [symbol] _{C}_{ₓ} := RPPR ( X̅, mₑ, [symbol] X mod mₑ [symbol] |
| (1.2) | nonzero_rrems := 0; |
| (1.3) | for i from 1 to Nmoduli do |

if ρᵢ ≠ 0 then nonzero_rrems := nonzero_rrems + 1; fi;

| | |
|---|---|
| | od; |
| (1.4) | if ( [symbol] _{C}_{ₓ} ≠ 0) then nonzero_rcx := 1; |
| | else |
| | nonzero_rcx := 0; |
| | fi; |

# In the numerical example: ρ := [10, 2, 2, 5, 2]; [symbol] _{C}_{ₓ} := 2; nonzero_rrems := 5; nonzero_rcx := 1;
# Step 2: Using the ρᵢ and the the [symbol] _{C}_{ₓ} values as “indexes”, look-up in parallel the touples T̅ᵢ[ρᵢ],
# scaled remainders Rrᵢ, QRcx, RRcx, and the corresponding extra_info values (all added in | |)
(2.1) T̅ᵢ := Quo_Tab_1 (i, ρᵢ, 3]; Rrᵢ := Quo_Tab_1[i, ρᵢ, 4]; i = 1, . . . , K
(2.2 ) Q̅R̅c̅x̅ := Quo_Tab_2[ [symbol] _{C}_{ₓ}, 3]; RRcx := Quo_Tab_2[rcx, 4];
(2.3) extra_info_Tᵢ := Quo_Tab_1[i, ρᵢ, 2]; extra_info_QRcx := Quo_Tab_2[ [symbol] _{C}_{ₓ}, 2];
/* In the example: T̅₁ := [4, 1, 8, 5, 1], T̅₂ := [2, 6, 7, 10, 11], T̅₃:= [4, 4, 8, 9, 6], T̅₄ := [0, 3, 4, 4, 1],
T̅₅ := [2, 1, 8, 6, 9] and Q̅R̅c̅x̅ = [4, 2, 0, 8, 15]. (Rr₁, Rr₂, Rr₃, Rr₄, Rr₅, Rrcx) := (47 63, 1, 78, 84, 22)
Note that there is no “extra-information” associated with the fractional-remainder values */
# Step 3: Execute accumulations in parallel in all the RNS and extra channel(s)
$\begin{matrix}( 3.1 ) {\overline{Q}}_{I} := ( \begin{matrix}K \\ + \\ i = 1\end{matrix} {\overline{T}}_{i} ) - \overline{QRcx} ; \\ ( 3.2 ) {\hat{Q}}_{f} = ( {\sum }_{j = 1}^{K} {Rr}_{j} ) - RRcx ;\end{matrix}$ $\text{/} * \pm denotes a component \text{-} wise addition \text{/} subtraction of touples in parallel in all the RNS channels .$
“Σ” denotes addition of scalars in the extra channel(s) In the example:
${\overline{Q}}_{I} = [ 4 , 1 , 8 , 5 , 1 ] + [ 2 , 6 , 7 , 10 , 11 ] + [ 4 , 4 , 8 , 9 , 6 ] + [ 0 , 3 , 4 , 4 , 1 ] + [ 2 , 1 , 8 , 6 , 9 ] - [ 4 , 5 , 0 , 8 , 15 ] = \\ [ ( 8 mod d ) , … , ( 13 mod 17 ) ] = [ 3 , 6 , 2 , 0 , 13 ] and {\hat{Q}}_{f} = ( 47 + 63 + 1 + 78 + 84 ) - 22 = 251 * \text{/}$
# Step 4: Set \hat{Q}f_unscaled := Unscaled \hat{Q}_{f}. Also evaluate bounds on \hat{Q}_{f}, and check if \hat{Q}_{f} is exact.
$\begin{matrix}( 4.1 ) \hat{Q} f\_unscaled := ⌊ \frac{( {\hat{Q}}_{f} )}{{b}^{w}} ⌋ ; \\ ( 4.2 ) {\hat{Q}}_{f \_ high} := ⌊ \frac{( {\hat{Q}}_{f} + nonzero\_rrems + nonzero\_rcx )}{{b}^{w}} ⌋ ;\end{matrix}$
# here, b is the base and w is the precision [symbol] only left-shift followed by truncation suffices
(4.3) \hat{Q}_{f}_ low := \hat{Q}f_unscaled

| | | |
|---|---|---|
| (4.4) fi; | if (\hat{Q}_{f}_low = \hat{Q}_{f}_high) then Q_is_exact := 1; else Q_is_exact := 0; | $\begin{matrix}£ In the example \text{:} \\ £ {\hat{Q}}_{f \_ lo w} := ⌊ \frac{251}{{10}^{2}} ⌋ = 2 ; and \\ £ {\hat{Q}}_{f \_ hig h} := ⌊ \frac{251 + 5 + 1}{{10}^{2}} ⌋ := 2 ; ⇒ \\ £ in the example , Q\_is \_exact := 1 ;\end{matrix}$ |

$\# Step 5 \text{:} evaluate \overline{Q} \text{:} convert \hat{Q} f\_unscaled into a residue \text{-} touple and add it to \overline{{Q}_{I}} \\ ( 5.1 ) {\overline{Q}}_{f\_touple} := vector ( K , i \to ( \hat{Q} f\_unscaled mod {m}_{i} ) ) ;$ $( 5.2 ) \overline{Q} := \overline{{Q}_{I}} + {\overline{Q}}_{f\_ toupl e} \# In the example \text{:} \overline{Q} := [ 3 , 6 , 2 , 0 , 13 ] + [ 2 , 2 , 2 , 2 , 2 ] = [ 0 , 1 , 4 , 2 , 15 ]$
# Step 6: Also generate \hat{Q} mod mₑ; the “disambiguation-bootstrapping” step
$( 6.1 ) extra\_info \_ \hat{Q} := [ ( {\sum }_{i = 1}^{K} extra\_info {\_T}_{i} ) - extra\_info \_QRcx ] mod {m}_{e} ;$
(6.2) extra_info_\hat{Q} := (extra_info_\hat{Q} + \hat{Q}f_unscaled) mod mₑ
# in the example: extra_info_\hat{Q} := ((1 + 0 + 0 + 0 + 0 − 0) mod 2 + 2) mod 2 = 1
(7) Output: Return ( \hat{Q̅} , (\hat{Q} mod mₑ), Q_is_exact);
End_Algorithm

/* In the example: Using the CRT, it can be verified that \overline{\hat{Q}}=[0, 1,4, 2,15]≡15 and (\hat{Q} mod mₑ) [symbol] 1.

It is also easy to independently check that

$$⌊ \frac{3249}{209} ⌋ = 15 ,$$

verifying the returned value of flag Q_is_exact */ We would like to clarify some important issues regarding the QFS algorithm.
\textcircled{1} From the residue touple \overline{\hat{Q}}, returned by the algorithm, the remainder can be directly estimated as a residue-touple; and the extra info value (\hat{R} mod mₑ) can also be evaluated using the fundamental division relation (Eqn (95) above):

\overline{\hat{R}}:= X̅ [symbol] ( \overline{\hat{Q}} [symbol] D̅) (109 )

\hat{R} mod mₑ:=[(X mod mₑ)−(\hat{Q} mod mₑ)×(D mod mₑ)]mod mₑ (110)
\textcircled{2} Note that the input X is made available to the algorithm only as a residue touple, not as a fully reconstructed decimal or binary integer. In addition, one extra bit_{—} conveyed by (X mod mₑ) is also required by the algorithm. Given these inputs, the algorithm generates \overline{\hat{Q}} as well as (\hat{Q} mod mₑ) (and therefore \overline{\hat{R}} and (\hat{R} mod mₑ) as per Eqns (109) and (110)), thereby demonstrating that the outputs are delivered consistently in the same format as the inputs.
\textcircled{3} The integer estimate \hat{Q} corresponding to the residue-touple \overline{\hat{Q}} can take only one of the two values

[symbol] If the variable/flag “Q_is_exact” is set to the value “1”, then \hat{Q}=Q, i.e., the estimate equals the exact integer quotient. In practice (numerical experiments) this happens in an overwhelmingly large number of cases.

[symbol] otherwise, the flag Q_is_exact=0, indicating that the algorithm could not determine whether or not \hat{Q} is exact. (because of the drastically reduced precision used to store the pre-computed fractions) In this case \hat{Q} could be exact, i.e., \hat{Q}=Q

or \hat{Q}=(Q−1), i.e., Q can under-estimate Q by a ulp.

Further disambiguation between these two values is possible by calculating the estimated-remainder \hat{R} and checking whether (\hat{R}−D) is +ve or −ve

Let the exact integer remainder be denoted by R. It is clear that the estimated integer-remainder \hat{R} can have only two possible values:

[symbol]

if \hat{Q} is exact, then \hat{R}=R, i.e., \hat{R} is also exact; or (111)

[symbol]

\hat{Q}=(Q−1) [symbol] \hat{R}=X31 (Q−1)D=(X−Q·D)+D=R+D (112)

In other words, in the relatively infrequent case [symbol] , performing a sign-detection on (\hat{R}−D) is guaranteed to identify the correct Q and R in all cases. (if (\hat{R}−D) is +ve, then it is clear that \hat{Q} underestimated Q by a ulp; otherwise \hat{Q}=Q)

§4.5.4 Estimation of the Delay of and the Memory Required for the QFS Algorithm

§4.5.4.A Delay Model and Latency Estimation

We assume dedicated h/w implementation of all channels (including the extra channels). Within each channel the look-up tables are also implemented in h/w (note that the tables need not be “writable”). All tables are independently readable in parallel with a latency of O(lgn). Likewise, since each component modulus is small as well as the number of channels (K) is also small, we assume that a dedicated adder-tree is available in each channel for the accumulations modulo the component-modulus for that channel. The latency of the accumulations can be also shown to be logarithmic in the word-length, i.e., O(lgn). Likewise, we assume that a fast, multistage or barrel shifter is available per channel so that delay of “variable: shifts is also O(lgn).

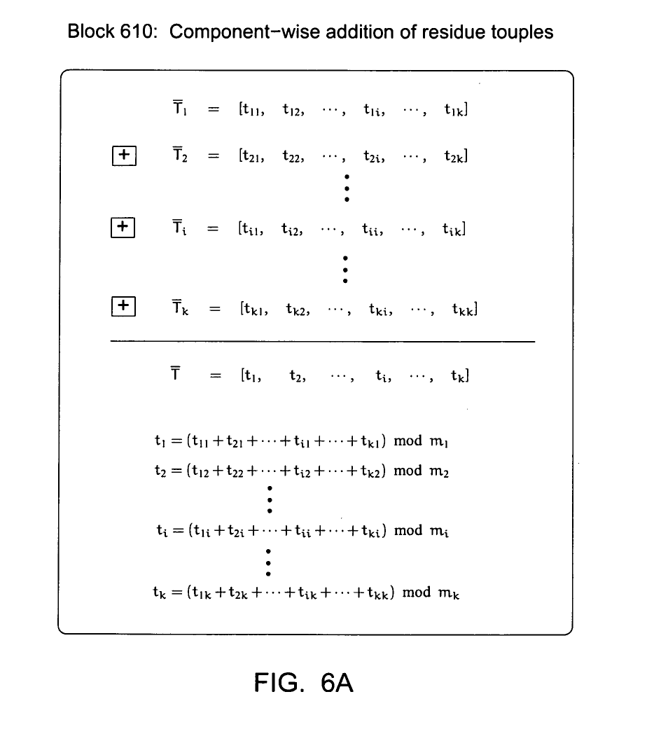

FIG. 7 illustrates a timing diagram showing the sequence of successive time-blocks in which the various steps of the QFS algorithm get executed. At the top of each block, we have also shown its latency as a function of (the overall RNS word-length) n, under the assumptions stated above.

Since the maximum latency of any of the blocks is O(lgn), the overall/total latency of the h/w implementation is estimated to be O(lgn).

§4.5.4.B Memory Requirements

In addition to the reconstruction table, we also need the Quotient Tables. The total number of number of entries in both parts of the Quotient table is O(K²/2)+O(K−1)=O(K²). In this case, each table entry has K+1 components, wherein, each component is no bigger than O(lglgK) bits. Consequently the total storage (in bits) that is required is ≈O(K³lglgK) bits ≈O(n³lglgn) bits.

§4.6 Modular Exponentiation Entirely within the Residue Domain

Modular exponentiation refers to evaluating (X^{Y} mod D). In many instances, in addition to D, the exponent Y is also known ahead of time (ex: in the RSA method, Y is the public or private-key). Our method does not need Y to be a constant, but we assume that it is a primary/external input to the algorithm and hence available in any desired format (in particular, we require the exponent Y as a binary integer, i.e., a string of w-bits).

$$\begin{matrix}Let Y = {y}_{w - 1} {2}^{w - 1} + {y}_{w - 2} {2}^{w - 2} + … + {y}_{2} {2}^{2} + {y}_{1} {2}^{1} + {y}_{0} \\ = ( … ( ( {y}_{w - 1} * 2 + {y}_{w - 2} ) * 2 + {y}_{w - 3} ) * 2 + … + {y}_{0} ) ( 114 )\end{matrix} \qquad ( 113 )$$

To the best of our knowledge, one of the fastest methods to perform modular exponentiation expresses the exponent Y as polynomial of radix 2, parenthesized as shown Eqn (114) above (known as the “Horner's method” of evaluating a polynomial). Since the coefficient of the leading-term in (113) must be non-zero, (i.e. y_{w-1}=1), the modular exponentiation starts with the initial value Ans:=X² mod D. If y_{w-2}≠0 then the result is multiplied (modulo-D) by X and is then squared. This operation is repeatedly performed in a loop as shown below:

| | | |
|---|---|---|
| # Initialization: | Ans = X² mod D; | mod_red_1 |
| # Loop: | for i from w − 2 by −1 to 1 do | |
| | curbit := Y[i]; | |
| | if curbit = 1 then | |
| | Ans := (Ans × X) mod D ; | mod_red_2 |
| | fi; | |
| | Ans := (Ans)² mod D; | mod_red_3 |
| | od; | |
| | if (y0 = 1) then Ans = (Ans × X) mod | mod_red_4 |
| | D; fi; | |

The obvious speedup mechanism is to deploy the QFS algorithm to realize each modular-reduction, aka, remaindering operation. (the remaindering operations needed in modular-exponentiation are tagged with the label “mod_red_n” inside a box at the end of the corresponding line in the maple-style pseudo-code above).

§4.6.1 Further Optimization: Avoiding Sign-Detection at the End of QFS

Result 3: Directly using the estimate \hat{\hat{Q}} to evaluate \overline{\hat{R}} as a residue-touple (as per Eqn (109) above), corresponds to an estimated integer-remainder \hat{R} that is in the same residue class (w.r.t. the Divisor D) as the correct remainder R

Proof: Immediately follows from the definition of the residue class:

Definition 1: Integers p and q are in the same residue class w.r.t. D if (p mod D=q mod D)

Eqns (111) and (112) show that \hat{R} ∈ {R, R+D} [symbol] it is in the same residue-class as the exact integer remainder R.

Next, we show that as long as the range of the RNS system is sufficiently large, it is possible to use incorrect values for the remainder at intermediate steps of modular exponentiation, (as long as they are in the proper residue class); and still generate the correct final result.

Result 4: If the inputs X₁ and X₂ to the QFS algorithm are in the same residue class w.r.t. the (constant/known) divisor D then the remainder estimates \hat{R}₁ and \hat{R}₂ evaluated using the quotient estimates \hat{Q}₁ and \hat{Q}₂ returned by the QFS algorithm both satisfy the constraints

\hat{R}₁ can assume only one of the two values: \hat{R}₁=R or \hat{R}₁=R+D (115)

\hat{R}₂ can assume only one of the two values: \hat{R}₂=R or \hat{R}₂=R+D (116)

where R is the correct/exact integer remainder. (this holds even if the “Q_is_exact” flag is set to 0, indicating that the algorithm could not determine whether or not the quotient estimate equals the exact quotient).

Result 5: If the range of the RNS is sufficiently large, then there is no need for a sign-detection at the end of the QFS algorithm in order to identify the correct remainder in intermediate steps during the modular-exponentiation operation.

Proof: Assume that at the end of some intermediate step i, \hat{Q}=(Q−1) thereby causing

Ansᵢ:=\hat{R}ᵢ=Rᵢ+D instead of the correct value Ansᵢ:=\hat{R}ᵢ=Rᵢ; (117)

Then, as seen in the pseudo-code for modular exponentiation (which is illustrated in Section §4.6.2) above, the next operation is either a modular-square or a modular-multiplication:

Ans₍ᵢ₊₁₎:=(Ansᵢ)² mod D or Ans₍ᵢ₊₁₎:=(Ansᵢ×X) mod D [symbol] (118)

Ans₍ᵢ₊₁₎:=(Rᵢ+D)² mod D or Ans₍ᵢ₊₁₎:=(Rᵢ+D)×X mod D (119)

instead of the correct values

Ans₍ᵢ₊₁₎:=Rᵢ² mod D or Ans₍ᵢ₊₁₎:=(Rᵢ×X) mod D

However, note that

Rⱼ² is in the same residue class w.r.t. D as (Rᵢ+D)² and (120)

[(Rᵢ+D)×X] is in the same residue class w.r.t. D as (Rᵢ×X) (121)

Therefore from claim 2 above, it follows that in either paths (modular-square or modular-product-by-X) the answers obtained at the end of the next step satisfy the exact same constraints, specified by Equations (115) and (116), independent of whether the answers (remainders) at the end of the previous step were exact or had an extra D in them; which shows that performing a sign-detection on the \hat{Q} returned by the QFS algorithm is not necessary.

Result 6: A single precision RNS range [symbol] 3D, and correspondingly a double-precision range [symbol] 9D² is sufficient to obviate the need for a sign-detection

Proof: Since the correct remainder satisfies the constraints 0 [symbol] R<D, it is clear that the erroneous remainder value (R+D) satisfies

0<D [symbol] (R+D)<2D (122)

As a result, the estimated remainder could be as high as about/almost 2D. We therefore set the single-precision range-limit to be 3D so that the full double length values could be as large as (3D)²=9D². Accordingly, we select K-smallest-consecutive prime numbers such that their product exceeds 9D². With this big a range, either modular-square or modular-multiplication using an inexact remainder does not cause overflow, as per constraint (122) above

§4.6.2 The ME-FWRD Algorithm: Maple-Style Pseudo-Code

```
# First we specify a procedure (“proc” in maple) which is a small wrapper around the QFS algorithm
QFS _rem_estimate := proc( X̅,(X mod mₑ))
  \overline{\hat{Q}}, \hat{Q}_mod_me, Q_is_exact := Quotient_First_Scaling_Estimate( X̅, [symbol]  X mod mₑ [symbol] )
  R_is_exact := Q_is_exact; # if \hat{Q} is exact then so is \hat{R}
  \hat{R}_mod_me := [X mod mₑ − \hat{Q}_mod_me ×(D mod mₑ)] mod mₑ; # bootstrapping...
  \overline{\hat{R}} = X̅ [symbol]   ( \overline{\hat{Q}} [symbol]    D̅);
  Return( \overline{\hat{R}}, \hat{R}_mod_me, R_is_exact);
  end proc ;
  Algorithm ModExp_Fully_Within_Residue_Domain ( X̅,(X mod mₑ), Y̅)
  # Inputs: X as a residue-touple, the extra-info, and Y as a w-bit binary-number
  # We assume that the constraint X < M has been enforced before converting the primary input X into
  # a residue-touple
  # Pre-computations: moduli where [symbol] [symbol]    9D², D_mod_me, D̅≡ residue-touple for D,...
  # and everything required by the QFS algorithm
  # Initializations
  A̅n̅s̅, Ans_mod_me, Ans_is_exact := qfs_rem_estimate( X̅, [symbol]  X mod mₑ [symbol] ) ;
  A̅n̅s̅:= A̅n̅s̅ [symbol]    A̅n̅s̅;
  Ans_mod_me := (Ans_mod_me)² mod mₑ  #bootstrapping...
  A̅n̅s̅, Ans_mod_me, Ans_is_exact := qfs_rem_estimate( A̅n̅s̅, Ans_mod_me) ;
  for i from w − 2 by −1 to 1 do  #Loop
      curbit := Y̅[i];
      if curbit = 1 then
          A̅n̅s̅:= A̅n̅s̅ [symbol]    X̅; Ans_mod_me := (Ans_mod_me × X_mod_me) mod mₑ;
          A̅n̅s̅, Ans_mod_me, Ans_is_exact := qfs_rem_estimate( A̅n̅s̅, Ans_mod_me) ;
      fi;
      A̅n̅s̅:= A̅n̅s̅ [symbol]    A̅n̅s̅; Ans_mod_me := (Ans_mod_me)² mod mₑ ;
      A̅n̅s̅, Ans_mod_me, Ans_is_exact := qfs_rem_estimate( A̅n̅s̅, Ans_mod_me) ;
  od;
  if (y₀ = 1) then # Ans = (Ans × X) mod D
      A̅n̅s̅:= A̅n̅s̅ [symbol]    X̅; Ans_mod_me := (Ans_mod_me × X_mod_me) mod mₑ ;
      A̅n̅s̅, Ans_mod_me, Ans_is_exact := qfs_rem_estimate( A̅n̅s̅, Ans_mod_me) ;
  fi;
      # Outputs: remainder-touple, extra-info, exactness-flag
  Return( A̅n̅s̅, Ans_mod_me, Ans_is_exact); □
  End_Algorithm
```

Correctness of the algorithm follows from the analytical results presented so far. Moreover the algorithm was implemented in Maple and extensively tested on a large number of cases.

§4.6.3 Delay Estimation of the Proposed Modular-Exponentiation Algorithm

Pre-computation costs are not considered (they represent one-time fixed costs).

(i) The main/dominant delay is determined by the delay of the loop.

Assuming that the exponent Y is about as big as D, the number of times the exponentiation loop is executed=lgY≈O(n) times.

(ii) Determination of the Quotient estimate is the most time-consuming operation in each iteration of the loop and it requires O(lgn) delay (as explained in Section §4.5.4-A).

As a result, each iteration of the loop requires (O(lgn) delay.

(iii) Therefore, the total delay is O(nlgn).

The memory requirements are exactly the same as those of the QFS algorithm: ≈O(n³lglgn) bits as shown above (in Section §4.5.4-B).

§4.6.4 Some Remarks about the ME-FWRD Algorithm

\textcircled{1} In a remaindering operation, it is possible to under-estimate the quotient, but it is not acceptable to over-estimate the quotient even by a ulp for the following reason:

if \hat{Q} is an over-estimate, then \hat{R}=X−\hat{Q}×D [symbol] 0 and therefore gets evaluated as (123)

\hat{R}≡ [symbol] −|\hat{R}| which is not in the same residue class w.r.t. D as the correct remainder R (124)

\textcircled{2} The algorithm always works in full (double) precision mode. In the RNS, increased word length simply requires some more channels. In a dedicated h/w implementation, all the channels can execute concurrently, fully leveraging the parallelism inherent in the system. Hence, the incremental delay (as a result of doubling the word-length) is minimal: Since doubling the word-length adds one-level to each adder/accumulation-tree (within each RNS-channel),

the incremental delay is ≈O(1).

§4.7 Convergence Division via Reciprocation to Handle Arbitrary, Dynamic Divisors

let X be a 2n bit dividend

X=Xᵢ·2ⁿ+Xₗ (125)

where Xᵤ is the upper-half (more-significant n bits) and Xₗ is the lower-half. Let D be an n bit-long divisor. Then, the quotient Q is

$$\begin{matrix}Q = ⌊ \frac{X}{D} ⌋ \\ = ⌊ \frac{{X}_{u} \cdot {2}^{n} + {X}_{l}}{D} ⌋ \\ = ⌊ \frac{{X}_{u} \cdot {2}^{n}}{D} ⌋ + ⌊ \frac{{X}_{l}}{D} ⌋ + δ \end{matrix} \\ wherein δ = \{ 0 , 1 \} \qquad ( 126 )$$

Since Xₗ and D are both n bit long numbers Xₗ<2D [symbol] (127)

$$⌊ \frac{{X}_{l}}{D} ⌋ = \{ \begin{matrix}0 & if {X}_{l} < D \\ 1 & otherwise\end{matrix} \qquad ( 128 )$$

The remaining term is

$$⌊ \frac{{X}_{u} \cdot {2}^{n}}{D} ⌋ wherein \frac{{X}_{u} \cdot {2}^{n}}{D} = \frac{{X}_{u}}{{D}_{f}} \\ where {D}_{f} = \frac{D}{{2}^{n}} ⇒ \frac{1}{2} \leq {D}_{f} < 1 \qquad ( 129 )$$

In the inequality above, the lower bound ½ follows from the fact that the leading bit of an n-bit long number D is 1 (if not, the word-length of D would be smaller than n). Also note that the maximum value of the n-bit integer D can be (2ⁿ−1), which yields the upper bound 1 on D_{f}.

$$\begin{matrix}Let {D}_{f\_inv} = \frac{1}{{D}_{f}} ⇒ 1 < {D}_{f\_inv} \leq 2 and let {D}_{f\_inv} = 1 + F where 0 < F \leq 1 & ( 130 ) \\ Then , \frac{{X}_{u}}{{D}_{f}} = {x}_{u} \times {D}_{f\_inv} = {X}_{u} ( 1 + F ) = {X}_{u} + {X}_{u} F ⇒ ⌊ \frac{{X}_{u}}{{D}_{f}} ⌋ = {X}_{u} + ⌊ {X}_{u} F ⌋ & ( 131 )\end{matrix}$$

From the last equality it is clear that in order to correctly evaluate └XᵤD_{f}_{_{—}}ᵢₙᵥ┘, the value of F (which is the fractional part of D_{f}_{_{—}}ᵢₙᵥ) must be evaluated upto at least n bits of precision.

To evaluate D_{f}_{_{—}}ᵢₙᵥ, let

$$Y = ( 1 - {D}_{f} ) ⇒ 0 < Y \leq \frac{1}{2} \qquad ( 132 )$$

Note that the integer Yᵢₙₜ=(2ⁿY)=(2ⁿ−D) (133)

(134)

Substituting D_{f} in terms of Y, yields

$$\begin{matrix}{D}_{f\_inv} = \frac{1}{{D}_{f}} \\ = \frac{1}{( 1 - Y )} \\ = \frac{( 1 + Y )}{( 1 - {Y}^{2} )} \\ = \frac{( 1 + Y ) ( 1 + {Y}^{2} )}{( 1 - {Y}^{4} )} \\ = … \\ = \frac{( 1 + Y ) ( 1 + {Y}^{2} ) … ( 1 + {Y}^{( {2}^{t} )} )}{( 1 - {Y}^{( {2}^{2 t} )} )}\end{matrix} \qquad ( 135 )$$

In the last set of equalities, since the numerator and the denominator of each successive expression are both multiplied by the same

factor of the form (1+Y⁽²^{ⁱ}⁾) at step i, i=0, 1, (136)

the original value of the reciprocal does not change. Also note that each successive multiplication by a factor of the above form doubles the number of leading ones in the denominator. As a result the denominator in the successive expressions in Eqn (135) approaches the value 1 from below (it becomes 0.11111 . . . ).

It is well known [6] that

when the number of leading-ones in the denominator exceeds the word-length (i.e., n bits),

the error ε in the numerator also satisfies the bound ″ε|<2⁻ⁿ

and the iterations can be stopped. In other words, when t leads to the satisfaction of the constraint

$$( 1 - {Y}^{( {2}^{2 t} )} ) \leq ( 1 - {2}^{( n )} ) ⇒ ( lgY ) {2}^{( 2 t )} \geq n ⇒ t \geq \frac{1}{2} ( lgn - lglgY ) \qquad ( 137 )$$

the iterations can be stopped and the approximation

$$\begin{matrix}{D}_{f\_inv} = \frac{( 1 + Y ) ( 1 + {Y}^{2} ) … ( 1 + {Y}^{( {2}^{t} )} )}{( 1 - {Y}^{( {2}^{2 t} )} )} \\ \approx \frac{( 1 + Y ) ( 1 + {Y}^{2} ) … ( 1 + {Y}^{( {2}^{t} )} )}{1}\end{matrix} \qquad ( 138 )$$

can be used. Thus, number of iterations in a convergence division is O(lg).

In contrast any digit-serial division fundamentally requires O(n) steps.

It turns out that the above convergence method is equivalent to newton-style convergence iterations (for details, please see any textbook on Computer Arithmetic [6,7]). Newton's method is quadratic which means that the error

εₙ₊₁ after the (n+1)th iteration ≈O((εₙ)²) (139)

which in-turn implies that the number of accurate bits doubles after each iteration (which is why convergence-division is the method of choice in high speed implementations).

From (138) it is clear that

D_{f}_{_{—}}ᵢₙᵥ≈(1+Y)(1+Y²) . . . . (1+Y⁽²^{^{t}}⁾)

Accordingly the products need to be accumulated, so as to yield a precision of 2ⁿ-bits at the end. Since a product of two n bit numbers (which includes a square) can be upto 2n bits long, the lower half of the double length product must be discarded retaining only the n most significant bits at every step. Each such retention of n most significant bits is tantamount to division by a constant, viz., 2ⁿ. Thus the QFS algorithm needs to be invoked at every step in the convergence division method. In general the SODIS algorithm is also needed at each step. Those familiar with the art will appreciate that using all the preceding algorithms unveiled herein, an ultrafast convergence division via reciprocation can be realized without ever having to leave the residue domain at any intermediate step.

§5 Application Scenarios

The difficulty of implementing some basic canonical operations such as base-extension, sign-detection, scaling, and division has prevented the widespread adoption of the RNS. The algorithms and apparata unveiled herein streamline and expedite all these fundamental operations, thereby removing all roadblocks and unleashing the full potential of the RNS. Since a number representation is a fundamental attribute that underlies all computing systems, expediting all arithmetic operations using the RNS can potentially affect all scenarios that include computing systems. The scenarios that are most directly impacted are listed below.
\textcircled{1} At long wordlengths the proposed system yields substantially faster implementations. Therefore, cryptographic processors are likely to adopt the RNS together with the algorithms unveiled in this document. All other long wordlength applications (such as running Sieves for factoring large numbers or listing the prime numbers within a given interval, etc) will substantially benefit from hardware as well as software implementations of the proposed number system and the accompanying algorithms
\textcircled{2} Digital Signal Processing is dominated by multiply and add operations. The proposed representation is therefore likely to be adopted in DSP processors.
   Scaling is particularly easy if the scaling factor is divisible by one or more of the component moduli.
   My method of selecting moduli uses all prime numbers up to a certain threshold value. So there is ample scope to select a scale factor that is divisible by one or more of the moduli. This is an added advantage of the method of moduli selection that I have adopted.
\textcircled{3} Ultra-fast counters, constant-time or wordlength-independent up/down counters are significantly faster as well as simpler to realize when the RNS system is used.
   Consequently, the theory as well as designs of such counters should switch over to using the RNS and the accompanying algorithms
\textcircled{4} Memory and cache organization/access is another potentially significant application area. Conceptually, memory needs be abstracted as though it were a “linear” storage because the indexing calculations in conventional (binary/decimal) number representations are easier when the memory is logically organized linearly. Adopting the RNS allows a different conceptual organization of storage resources (ex: under RNS, storage can be conceptualized as a collection of buckets)
\textcircled{5} Realization of hash functions is faster and easier when there is native/hardware support for modulo operations that are required in the RNS. That in turn opens up other possibilities to further streamline and expedite other algorithms and/or apparata (such as Bloom filters, for instance).
\textcircled{6} Coding Theory and practice have pretty much revolved around conventional number representations. RN systems offer a rich mix of choices to further improve coding theory and practice.
\textcircled{7} Hardware implementations based on the RNS are inherently more parallel, since all channels can do their processing independently, thereby increasing the “locality” of processing and drastically reducing long interconnects. This in turn makes the circuits more compact and faster while simultaneously requiring substantially lower amount of power (than equivalent circuits based on conventional number representations). Moreover, the independence of channels makes the hardware lot easier to test (VLSI testing is a critically important issue). Finally, hardware realizations based on the RNS are more reliable.
\textcircled{8} Even when the RNS is implemented in software, it can still improve the utilization of the multi-core processors today. Channel(s) in the RNS could be dynamically mapped onto threads which could in turn be dynamically allocated and executed on any of the multiple cores.
\textcircled{9} Random number generation based on RNS system is another area that appears to have a great potential.
\textcircled{10} Theoretical Issues: for instance the Remainder Theorem constitutes an “orthogonal” decomposition (in a sense analogous to the Discrete Fourier Transform, i.e., the DFT). This is why multiplication (which is a convolution) becomes so simple, all the cross-terms go away . . . .
   What kind of redundancy is there in RNS representation?
   The novelty of the methods unveiled herein lies in their use of both the integer as well as fractional parts rather than sticking to only one. Can such methods be further extended and applied to other well know hard problems ? are these methods related to “Interior Point Methods”?

5.1 Distinctions and Novel Aspects of this Invention
\textcircled{1} All of the algorithms make maximal use of those intermediate variables whose values can be expressed as the most significant digits of a computation (the reader can verify that this is the case in the “RPPR”, SODIS, as well as the QFS algorithm)
   This enables the use of approximation methods.
\textcircled{2} Accuracy of approximation is in turn related to the precision required. The algorithms therefore use the minimal amount of precision necessary for the computation.
   I leverage the rational domain interpretation (i.e., joint integer as well as fractional domain interpretations) of the Chinese Remainder Theorem in order to drastically reduce the precision of the fractional values that need to be pre-computed and stored in look-up tables. It turns out that a drastic reduction of precision from n-bits to ┌lgn┐ bits still allows a highly accurate estimation of some canonical intermediate variables, wherein the estimate can be off only by a ulp. In other words, the exact value of the computation can be narrowed down to a pair of successive integers. This strategy is adopted in all the methods (viz, RPPR, SODIS, as well as the QFS algorithms)
   The novel “disambiguation” step then selects the right answer(by disambiguating between the two choices) in all cases.
   In other words, in a fundamental sense, I have identified the optimal mix of which and how much information from the fractional domain needs be combined with which specific portion of the information available from the integer-domain interpretation of the CRT in order to achieve ultrafast execution; and developed new methods that fully exploit that optimal mix.
\textcircled{3} My Moduli selection method simultaneously achieves three optimizations:
   O1: It maximizes the amount of pre-computation to the fullest extent; making it possible to deploy exhaustive look-up tables that cover all possible input cases.
   O2: Simultaneously, it also minimizes the amount of memory required (otherwise an exhaustive look-up would not be feasible at long bit-lengths).
   O3: It minimizes the size that each individual component-modulus ntᵢ can assume. The net effect is that the RNS is realized via a moderately large number of channels, each of which has a very small modulus.
   In other words, the moduli-selection brings out the parallelism inherent in the RNS to the fullest extent.
\textcircled{4} The said moduli selection therefore leads to two critical benefits
   B+1: Exhaustive pre-computation implies that there is very little left to be done at run-time, which leads to ultrafast execution (a good example is the Quotient First Scaling (QFS) algorithm).
   B+2: Exploiting the parallelism to the fullest extent while also using the smallest amount of memory further speeds up execution and cuts down on area and power consumption of hardware realizations.
\textcircled{5} All of the prior works published hitherto had a narrower focus. For example, [9], [12] (and their derivatives that have appeared since) are mainly concerned with “base-extension”. On the other hand, Vi's first paper [16] was aimed at “fault detection in flight control systems”; while the follow-on journal paper [17] was focused on “sign-detection”. Likewise, Lu's work [25,26] was mainly focused on a more efficient sign-detection and its application to division in the RNS.
   In contrast, we have developed a unified framework that expedites all the difficult RNS operations simultaneously.
\textcircled{6} The algorithms can be implemented in software (wherein the computation within each channel is done within a separate thread and the multiple threads get dynamically mapped onto different cores in a multi-core processor) or in hardware. In either case they offer a wide spectrum of choices that trade-off polynomially increasing amounts of pre-computations and look-up-table memory to achieve higher speed. In other words the algorithms are flexible and allow the designer a wide array of choices for deployment.

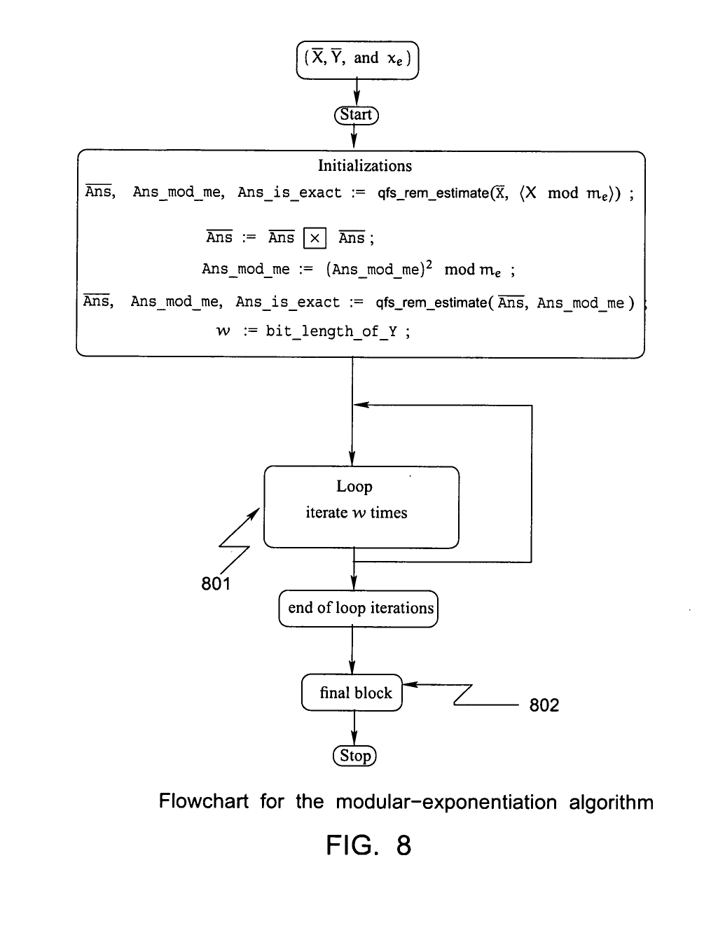

FIG. 9 is a flow chart representation of a process 900 of performing reconstruction using a residue number system. At box 902, a set of moduli is selected. At box 904, a reconstruction coefficient is estimated based on the selected set of moduli. At box 906, a reconstruction operation using the reconstruction coefficient is performed. As previously discussed, in some designs, additional operations may also be performed using the reconstruction operation.

In some designs, the operation of selecting the set of moduli is done so as to enable an exhaustive pre-computation and look-up strategy that covers all possible inputs. In some designs, the determination of reconstruction coefficient may be performed in hardware such that the determination is upper limited by delay of O(log n) where n is an integer number representing wordlength.

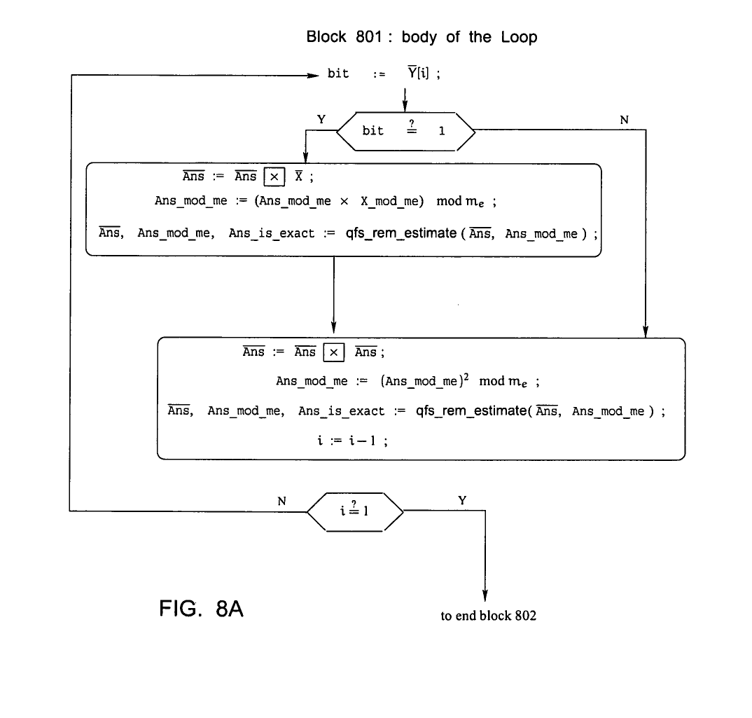

FIG. 10 is a block diagram representation of a portion of an apparatus 1000 for performing reconstruction using a residue number system. The module 1002 is provided for selecting a set of moduli. The module 1004 is provided for estimating a reconstruction coefficient based on the selected set of moduli. The module 1004 is provided for performing a reconstruction operation using the reconstruction coefficient.

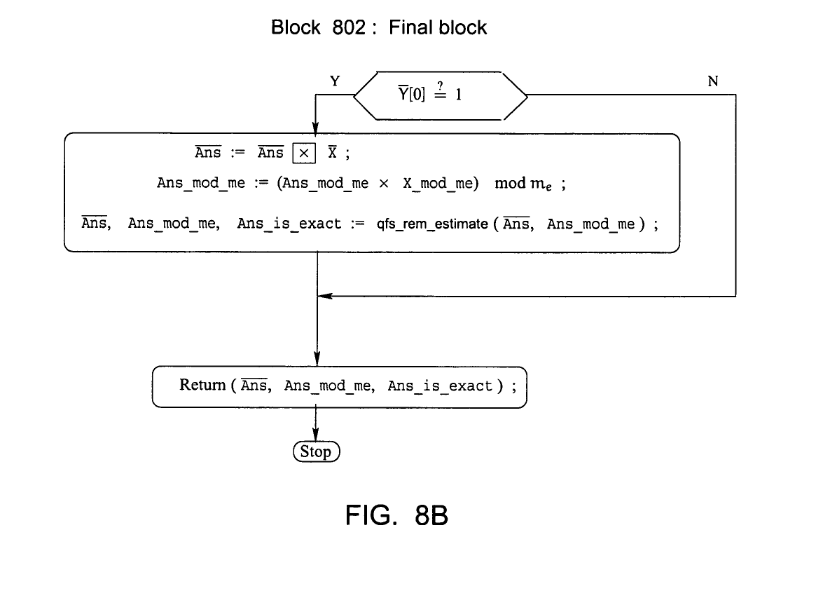

FIG. 11 is a flow chart representation of a process 1100 of performing division using a residue number system. At box 1102, a set of moduli is selected. At box 1104, a reconstruction coefficient is determined. At box 1106, a quotient is determined using an exhaustive pre-computation and a look-up strategy that covers all possible inputs.

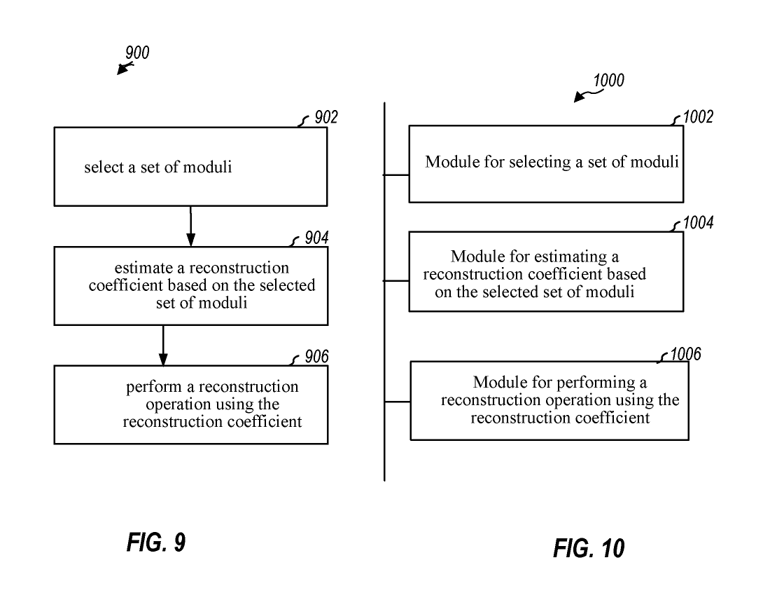

FIG. 12 is a block diagram representation of a portion of an apparatus 1200 for performing division using a residue number system. The module 1202 is provide for selecting a set of moduli. The module 1204 is provided for determining a reconstruction coefficient. The module 1206 is provided for determining a quotient using an exhaustive pre-computation and a look-up strategy that covers all possible inputs.

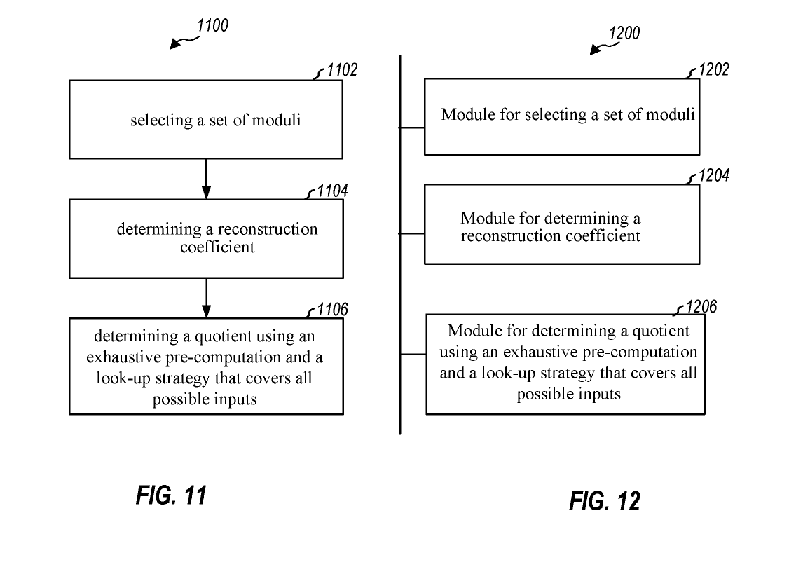

FIG. 13 is a flow chart representation of a process 1300 of computing a modular exponentiation using a residue number system. At box 1302, iterations are performed without converting to a regular integer representation, by performing modulator multiplications and modular squaring. At box 1304, the modular exponentiation is computed as a result of the iterations.

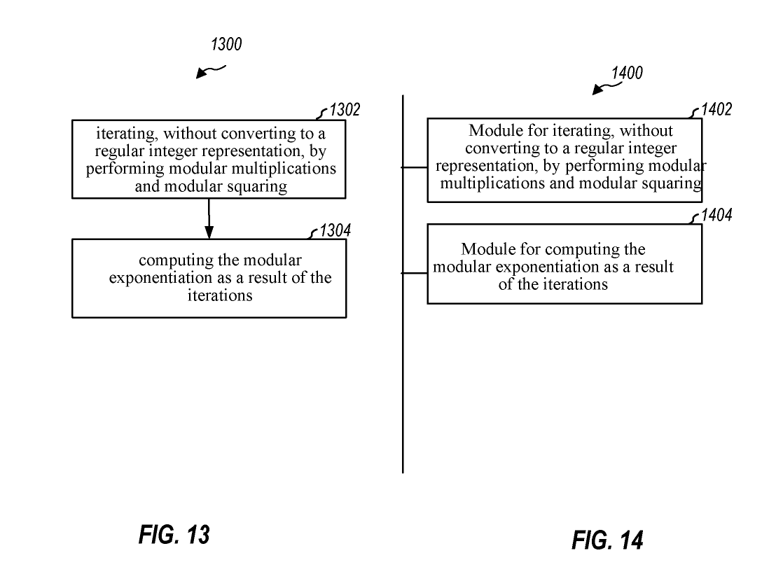

FIG. 14 is a block diagram representation of a portion of an apparatus 1400 for computing a modular exponentiation using a residue number system. The module 1402 is provided for iterating, without converting to a regular integer representation, by performing modular multiplications and modular squaring. The module 1404 is provided for computing the modular exponentiation as a result of the iterations.

It is noted that in one or more exemplary embodiments described herein, the functions and modules described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blue-ray disc where disks usually reproduce data magnetically, while discs reproduce data optically with lasers. Combinations of the above should also be included within the scope of computer-readable media.

As utilized in the subject disclosure, the terms [symbol] \check{r}system, [symbol] ś [symbol] \check{r}module, [symbol] ś [symbol] \check{r}component, [symbol] ś [symbol] \check{r}interface, [symbol] ś and the like are likewise intended to refer to a computer-related entity, either hardware, a combination of hardware and software, software, or software in execution. Components can include circuitry, e.g., processing unit(s) or processor(s), that enables at least part of the functionality of the components or other component(s) functionally connected (e.g., communicatively coupled) thereto. As an example, a component may be, but is not limited to being, a process running on a processor, a processor, a machine-readable storage medium, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The aforementioned systems have been described with respect to interaction between several components and modules. It can be appreciated that such systems, modules and components can include those components or specified sub-components, some of the specified components or sub-components, and/or additional components, and according to various permutations and combinations of the foregoing. Sub-components also can be implemented as components communicatively coupled to other components rather than included within parent component(s). Additionally, it should be noted that one or more components may be combined into a single component providing aggregate functionality or divided into several separate sub-components and may be provided to communicatively couple to such sub-components in order to provide integrated functionality. Any components described herein may also interact with one or more other components not specifically described herein but generally known by those of skill in the art.

Moreover, aspects of the claimed subject matter may be implemented as a method, apparatus, or article of manufacture using standard programming and/or engineering techniques to produce software, firmware, hardware, or any combination thereof to control a computer or computing components to implement various aspects of the claimed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips, optical disks (e.g., compact disk (CD), digital versatile disk (DVD), smart cards, and flash memory devices (e.g., card, stick, key drive. Additionally it should be appreciated that a carrier wave can be employed to carry computer-readable electronic data such as those used in transmitting and receiving voice mail or in accessing a network such as a cellular network. Of course, those skilled in the art will recognize many modifications may be made to this configuration without departing from the scope or spirit of what is described herein.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term [symbol] \check{r}includes [symbol] ś is used in either the detailed description or the claims, such term is intended to be inclusive in a manner similar to the term [symbol] \check{r}comprising [symbol] ś as [symbol] \check{r}comprising [symbol] ś is interpreted when employed as a transitional word in a claim.

What is claimed is:

1. A method of performing reconstruction using a residue number system, comprising;
selecting a set of moduli;
estimating a reconstruction coefficient based on the selected set of moduli; and
performing a reconstruction operation using the reconstruction coefficient.

2. The method of claim 1, wherein the selecting the set of moduli is done so as to enable an exhaustive pre-computation and look-up strategy that covers all possible inputs.

3. The method of claim 1, wherein the reconstruction coefficient is determined in a delay limit of O(log n).

4. The method of claim 1 wherein the estimating comprises:
computing a plurality of reconstruction reminders; and
quantizing the plurality of reconstruction reminders.

5. The method of claim 4 wherein the quantization comprises:
expressing the reconstruction remainders as proper fractions;
pre-computing the proper fractions in a pre-determined radix b;
truncating the proper fractions to a precision of no more than (┌log_{b} log_{b} [symbol] ┐) radix-b fractional digits;
scaling the truncated proper fractions by a scale factor so that multiplication by the scale factor simply amounts to a left-shifting of base-b digits and yields an integer value; and
storing the resulting integer values in look-up tables, wherein each RNS channel 1, with component-modulus mᵢ requires one look-up table with (mᵢ−1) entries.

6. The method of claim 5, wherein, channel look-up tables are read-only and are accessed completely independently of one another

7. The method of claim 1 wherein all the operands are integers and all the arithmetic operations are carried out with an ultra-low precision of no more than (┌log_{b} K┐+┌log_{b} log_{b}M┐) radix-b digits.

8. The method of claim 1 wherein the estimate consists of a pair of consecutive integers, one of which is the correct value of the reconstruction coefficient.

9. The method of claim 8, wherein, a disambiguation step is required to select the correct answer from among the two choices, by using an independent extra bit of information which is maintained in the form of one extra residue, i.e., remainder, with respect to an extra “disambiguator-modulus” mₑ that satisfies the condition: gcd( [symbol] , mₑ)<mₑ

10. The method of claim 9, wherein, a systematic “disambiguation-bootstrapping” process is required (and is therefore adopted) to ensure that this extra remainder is always available for any value that the method encounters.

11. A method of performing division using a residue number system, comprising:
selecting a set of moduli;
determining a reconstruction coefficient; and
determining a quotient using an exhaustive pre-computation and a look-up strategy that covers all possible inputs.

12. The method of claim 11, wherein, the disambiguation bootstrapping information regarding the determined quotient Q is also computed.

13. A method of computing a modular exponentiation in a residue number system, comprising:
iterating, without converting to a regular integer representation, by performing modular multiplications and modular squaring;
computing the modular exponentiation as a result of the iterations.

14. The method of claim 13, wherein there is no conversion between distinct moduli sets within a residue domain at any intermediate step throughout the computing process.

15. An apparatus for performing reconstruction using a residue number system, comprising:
means for selecting a set of moduli;
means for estimating a reconstruction coefficient based on the selected set of moduli;
and
means for performing a reconstruction operation using the reconstruction coefficient.

16. A computer program product comprising a non-volatile, computer-readable medium, storing computer-executable instructions for performing reconstruction using a residue number system, the instructions comprising code for:
selecting a set of moduli;
estimating a reconstruction coefficient based on the selected set of moduli; and
performing a reconstruction operation using the reconstruction coefficient.
